(19) United States
(12) Patent Application Publication
(10) Pub. No.: US 2013/0188078 A1
(43) Pub. Date: Jul. 25, 2013

(54) IMAGE SENSOR, OPERATING METHOD THEREOF, AND PORTABLE DEVICE HAVING THE SAME

(71) Applicants: Eun Sub SHIM, Anyang-si (KR); Kyung Ho LEE, Bucheon-si (KR); Moo Sup LIM, Yongin-si (KR); Jung Chak AHN, Yongin-si (KR)

(72) Inventors: Eun Sub SHIM, Anyang-si (KR); Kyung Ho LEE, Bucheon-si (KR); Moo Sup LIM, Yongin-si (KR); Jung Chak AHN, Yongin-si (KR)

(73) Assignee: SAMSUNG ELECTRONICS CO., LTD., Suwon-si (KR)

(21) Appl. No.: 13/616,393

(22) Filed: Sep. 14, 2012

(30) Foreign Application Priority Data
Jan. 19, 2012 (KR) 1020120006229

(51) Int. Cl. H01L 27/146; H04N 5/335

(52) U.S. Cl. 348/308; 250/206; 250/208.1; 348/E05.091

(57) ABSTRACT

An image sensor includes a photo detector for accumulating charges in response to an incident light, a storage unit for storing the charges, a first transmission gate for transmitting the charges from the photo detector to the storage unit, a second transmission gate for transmitting the charges from the storage unit to the floating diffusion node, a reset gate for resetting the floating diffusion node in response a reset gate signal, and a coupling circuit connected between the reset gate and the storage unit.

### CROSS-REFERENCE TO RELATED APPLICATIONS

This application claims priority under 35 U.S.C. §119(a) to Korean Patent Application No. 10-2012-0006229 filed on Jan. 19, 2012, the entire contents of which are hereby incorporated by reference.

### BACKGROUND

Embodiments of the present inventive concepts relate to an image sensor, and more particularly, to an image sensor including a pixel which may improve a transmission efficiency of charges, an operating method thereof and a portable device having the same.

An image sensor is a device that converts an optical image into an electrical signal. The image sensor may be used in a digital camera or other image devices. The image sensor may operate by reading the image line by line. Accordingly, there may be a gap in time between reading lines. Therefore, when the image sensor captures a fast moving object, there may be distortion in a captured image due to the time gap. To prevent the distortion, an electronic shutter may be used to expose the image sensor to light at a same rate as a frame interval or at a faster rate without using a mechanical shutter. Efficiency of the electronic shutter may be improved by transmitting charges efficiently from a pixel included in the image sensor.

### SUMMARY

An embodiment of the present invention is directed to an image sensor, including a photo detector configured to accumulate charges in response to an incident light, a storage unit configured to store the charges, a first transmission gate configured to transmit the charges from the photo detector to the storage unit, a second transmission gate configured to transmit the charges from the storage unit to a floating diffusion node, a reset gate configured to reset the floating diffusion node in response to a reset gate signal, and a coupling circuit connected between the reset gate and the storage unit.

The coupling circuit may be a capacitor.

The storage unit may be configured to have a first electric potential when the reset gate signal has a low level and the storage unit may be configured to have a second electric potential when the reset gate signal has a low level, the first electric potential being greater than the second electric potential. According to an example embodiment, the image sensor may further include an overflow gate configured to prevent the charges from flowing over the photo detector. The photo detector is configured to transmit the charges to the storage unit, if the reset gate signal having a high level is applied to the reset gate.

The storage unit is configured to transmit the charges to the floating diffusion node, if reset gate signal having a low level is applied to the reset gate. The storage unit may be a storage diode.

An example embodiment of the present inventive concepts is directed to an operating method of an image sensor, including resetting one or more of a photo detector, a storage unit and a floating diffusion node, accumulating charges in the photo detector, and applying a reset gate signal having a high level to a reset gate to transmit the charges accumulated by the photo detector from the photo detector to the storage unit.

The resetting includes resetting the floating diffusion node by using the reset gate signal having a high level, resetting the photo detector by using a first transmission gate signal transmitted during a first activation window, and resetting the storage unit by using a second transmission gate signal during a second activation window.

The second activation window includes the first activation window. The resetting includes resetting the photo detector by using an overflow gate signal having a high level.

An example embodiment of the present inventive concepts is directed to a portable device, including the image sensor and a display configured to display data processed by the image sensor.

Another example embodiment of the present inventive concepts is directed to a pixel array including a plurality of pixels. Each pixel including, a photo detector configured to accumulate charges; a storage unit configured to selectively receive the charges from the photo detector according to a first transmission signal; a floating diffusion node configured to selectively receive a reset voltage according to a reset signal and selectively receive the charges from the storage unit according to a second transmission signal; and a coupling circuit configured to increase an electric potential at the storage unit during a period where the storage unit receives the charges from the photo detector.

### BRIEF DESCRIPTION OF THE DRAWINGS

The above and other features and advantages will become more apparent by describing in detail example embodiments thereof with reference to the attached drawings in which:

FIG. 1 is a block diagram of an image processing device according to an example embodiment of the present inventive concepts;

FIG. 2 is a circuit diagram depicting an example embodiment of a pixel embodied in a pixel array illustrated in FIG. 1;

FIG. 3 is a top view of the pixel illustrated in FIG. 2;

FIG. 4 is a cross-sectional diagram of the pixel illustrated in FIG. 2;

FIG. 5 is an example embodiment of an electric potential diagram of the pixel illustrated in FIG. 2;

FIG. 6 is another example embodiment of the electric potential diagram of the pixel illustrated in FIG. 2;

FIG. 7 is a timing diagram of control signals for explaining an example embodiment of an operating method of the pixel illustrated in FIG. 2:

FIG. 8 is a timing diagram of control signals for explaining another example embodiment of the operating method of the pixel illustrated in FIG. 2;

FIG. 9 is a circuit diagram depicting another example embodiment of the pixel embodied in the pixel array illustrated in FIG. 1;

FIG. 10 is a timing diagram of control signals for explaining an example embodiment of an operating method of the pixel illustrated in FIG. 9;

FIG. 11 is a timing diagram of control signals for explaining another example embodiment of the operating method of the pixel illustrated in FIG. 9;

FIG. 12 is a timing diagram of control signals for explaining still another example embodiment of the operating method of the pixel illustrated in FIG. 9;

FIG. 13 is a timing diagram depicting an operating method according to still another example embodiment of the pixel illustrated in FIG. 9;

FIG. 14 is a circuit diagram depicting still another example embodiment of the pixel embodied in the pixel array illustrated in FIG. 1;

FIG. 15 is an example embodiment of an electric potential diagram of the pixel illustrated in FIG. 14;

FIG. 16 is another example embodiment of the electric potential diagram of the pixel illustrated in FIG. 14;

FIG. 17 is a timing diagram of control signals for explaining an example embodiment of an operating method of the pixel illustrated in FIG. 14;

FIG. 18 is a timing diagram of control signals for explaining another example embodiment of the operating method of the pixel illustrated in FIG. 14;

FIG. 19 is a circuit diagram depicting another example embodiment of the pixel embodied in the pixel array illustrated in FIG. 1;

FIG. 20 is a timing diagram of control signals for explaining an example embodiment of an operating method of the pixel illustrated in FIG. 19;

FIG. 21 is a timing diagram of control signals for explaining another example embodiment of the operating method of the pixel illustrated in FIG. 19;

FIG. 22 is a timing diagram of control signals for explaining still another example embodiment of the operating method of the pixel illustrated in FIG. 19;

FIG. 23 is a timing diagram of control signals for explaining still another example embodiment of the operating method of the pixel illustrated in FIG. 19; and

FIG. 24 is a block diagram depicting another example embodiment of the image device including the pixel illustrated in FIG. 2, 9, 14 or 19.

### DETAILED DESCRIPTION

Example embodiments now will be described more fully hereinafter with reference to the accompanying drawings, in which example embodiments are shown. Example embodiments may, however, be embodied in many different forms and should not be construed as limited to example embodiments set forth herein. Rather, example embodiments are provided so that this disclosure will be thorough and complete, and will fully convey the scope of example embodiments to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “I”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises,” “comprising,” “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

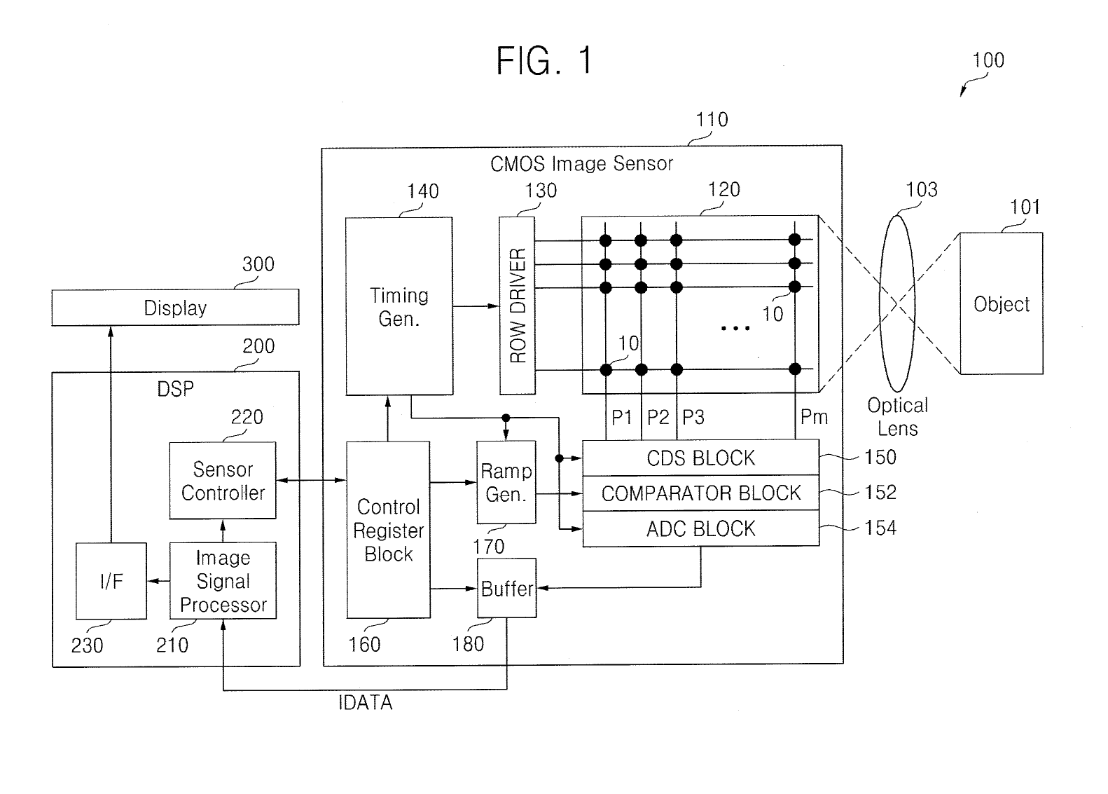

FIG. 1 is a block diagram of an image processing device according to an example embodiment of the present inventive concepts. Referring to FIG. 1, an image processing device 100 may be embodied in a portable device, e.g., a digital camera, a mobile phone, a smart phone, or a tablet personal computer (PC).

The image processing device 100 includes an optical lens 103, an image sensor 110, a digital signal processor (DSP) 200 and a display 300.

The image sensor 110 generates image data IDATA for a photographed or captured object 101 through the optical lens 103. The image sensor 110 may be embodied in a CMOS image sensor. The image sensor 110 includes a pixel array 120, a row driver 130, a timing generator 140, a correlated double sampling(CDS) block 150, a comparator block 152, an analog to digital conversion(ADC) block 154, a control register block 160, a ramp signal generator 170 and a buffer 180.

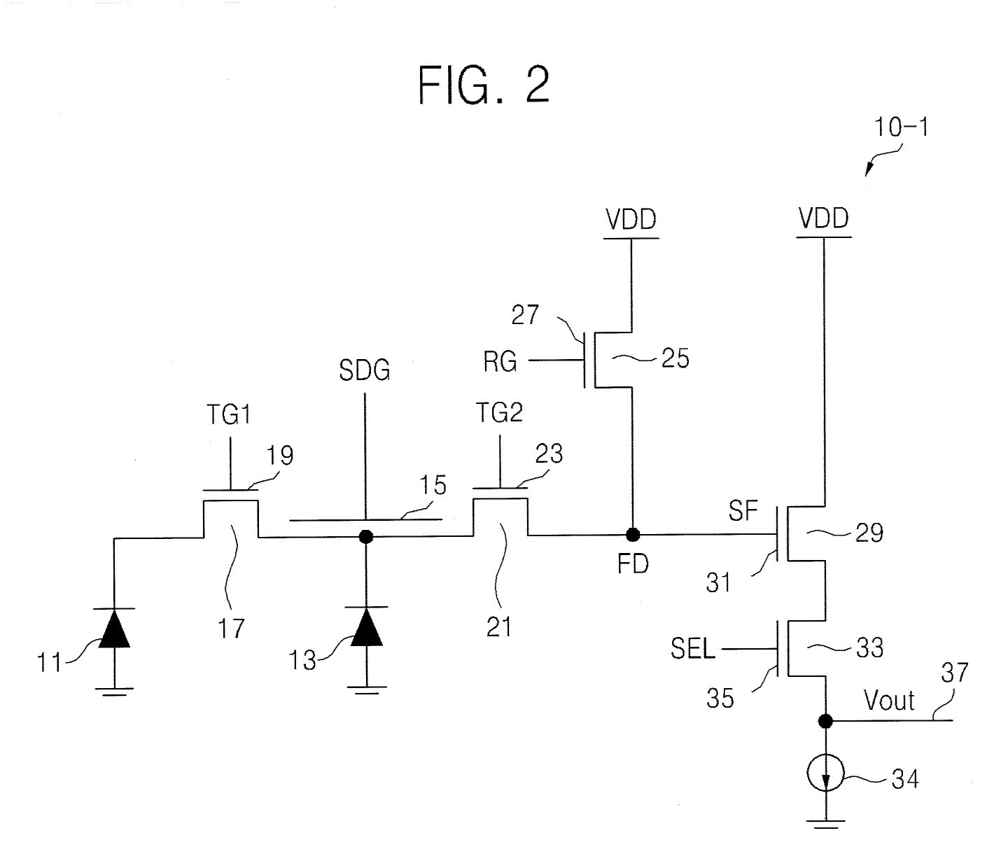

A pixel array 120 includes a plurality of pixels 10 arranged in a form of matrix. A structure and an operation of each of the plurality of pixels 10 will be explained in detail referring to FIGS. 2 to 23. A row driver 130 drives a plurality of control signals for controlling an operation of each of the plurality of pixels 10 to the pixel array 120 according to a control of a timing generator 140.

The timing generator 140 controls an operation of the row driver 130, a CDS block 150, an ADC block 154 and a ramp signal generator 170 according to a control of a control register block 160. The CDS block 150 performs a correlated double sampling on each pixel signal P1 to Pm, where m is a natural number, output from each of a plurality of column lines embodied in the pixel array 120.

The comparator block 152 compares each of a plurality of correlated double sampled pixel signals output from the CDS block 150 with a ramp signal output from the ramp signal generator 170 and outputs a plurality of comparison signals.

The ADC block 154 converts each of the plurality of comparison signals output from the comparator block 152 into a digital signal and outputs a plurality of digital signals to the buffer 180.

The control register block 160 controls an operation of the timing generator 140, the ramp signal generator 170 and the buffer 180 according to a control of a digital signal processor DSP 200. The buffer 180 transmits image data IDATA corresponding to a plurality of digital signals output from the analog to digital conversion block 154 to the digital signal processor DSP 200.

The digital signal processor 200 includes an image signal processor ISP 210, a sensor controller 220 and an interface 230.

The image signal processor 210 controls the sensor controller 220, which controls the control register block 160, and the interface 230. According to an example embodiment, the image sensor 110 and the digital signal processor 200 may be embodied in a single package, e.g., a multi-chip package. According to another example embodiment, the image sensor 110 and the image signal processor 210 may be embodied in a single package, e.g., a multi-chip package. The image signal processor 210 processes image data IDATA transmitted from the buffer 180 and transmits processed image data to the interface 230. The sensor controller 220 generates various control signals for controlling the control register block 160 according to a control of the image signal processor 210. The interface 230 transmits image data processed by the image signal processor 210 to a display 300. The display 300 displays image data output from the interface 230. The display 300 may be embodied in a thin film transistor-liquid crystal display(FTF-LCD), a light emitting diode(LED) display, an organic LED(OLED) display or an active-matrix OLED(AMOLED) display.

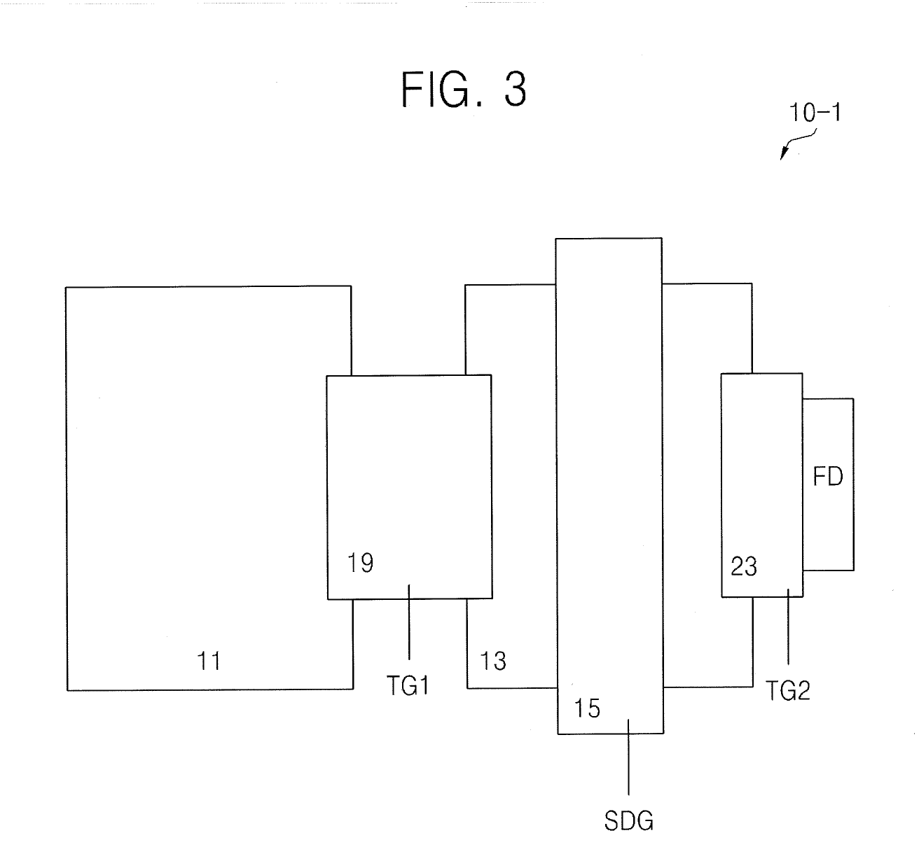

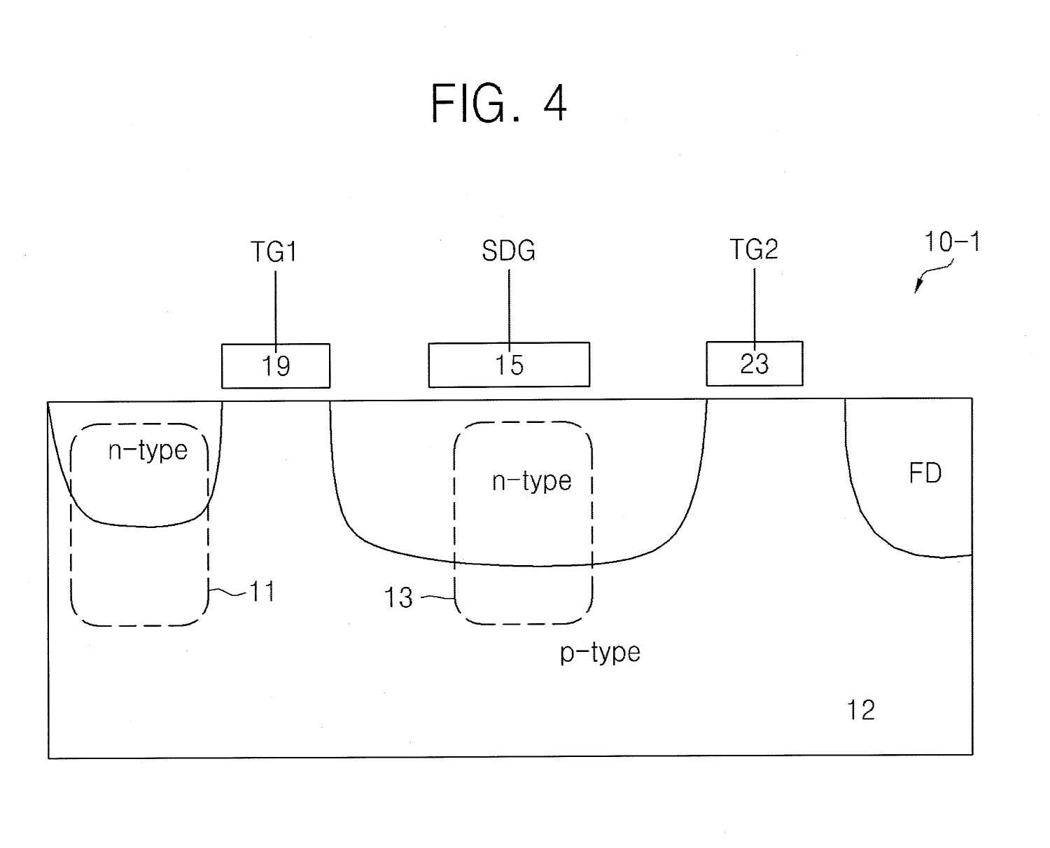

FIG. 2 is a circuit diagram depicting an example embodiment of a pixel embodied in the pixel array illustrated in FIG. 1. FIG. 3 is a top view of the pixel illustrated in FIG. 2, and FIG. 4 is a cross-sectional diagram of the pixel illustrated in FIG. 2. For convenience of explanation, only a part of the pixel is illustrated in FIGS. 3 and 4.

Referring to FIGS. 1 to 4, a pixel 10-1 according to an example embodiment of a pixel 10 includes a photo detector 11, a storage unit 13, a first transmission transistor 17, a second transmission transistor 21, a reset transistor 25, a source follower output transistor 29, a selection transistor 33, and a current source 34.

The photo detector 11 accumulates charges in response to an incident light. The photo detector 11 may be a photo diode, a photo transistor or a pinned photodiode. A storage unit 13 stores the charges. The storage unit 13 may be embodied in a storage diode.

The pixel 10-1 is formed at an upper part of the storage unit 13 and includes a boosting gate 15. The boosting gate 15 is controlled by a boosting signal SDG. The boosting signal SDG may be output from the row driver 130.

The first transmission transistor 17 is connected between the photo detector 11 and the storage unit 13. The first transmission transistor 17 includes a first transmission gate 19.

The first transmission transistor 17 is used to transmit the charges from the photo detector 11 to the storage unit 13. The first transmission transistor 17 is activated by a first transmission gate signal TG1. For example, when the first transmission gate signal TG1 is at a high level, the first transmission transistor 17 may be activated.

The second transmission transistor 21 is connected between a floating diffusion node FD and the storage unit 13. The second transmission transistor 21 includes a second transmission gate 23. The second transmission gate 23 is used to transmit the charges from the storage unit 13 to the floating diffusion node FD. The second transmission transistor 21 is activated by a second transmission gate signal TG2. For example, when the second transmission gate signal TG2 is at a high level, the second transmission transistor 21 may be activated.

The reset transistor 25 is connected between a node supplying a supply voltage VDD and the floating diffusion node FD. The reset transistor 25 includes a reset gate 27. The reset gate 27 is used to reset the photo detector 11, the storage unit 13 and/or the floating diffusion node FD. The reset transistor 25 is activated by a reset gate signal RG. For example, when the reset gate signal RG is at a high level, the reset transistor 25 may be activated.

The source follower output transistor 29 includes a source follower gate 31. The source follower gate 31 is connected to the floating diffusion node FD. The source follower output transistor 29 converts charges stored in the floating diffusion node FD into an output voltage Vout.

The selection transistor 33 is connected between a source of the source follower output transistor 29 and a ground. The selection transistor 33 includes a selection gate 35. The selection gate 35 is used to output an output voltage Vout to a column line 37 selectively in response to a selection signal SEL. For example, when the selection signal SEL is at a high level, the selection gate 35 outputs an output voltage Vout to the column line 37 as a pixel signal. The current source 34 operates as an active load. A plurality of control signals (TG1, TG2, RG and SEL) are output from the row driver 130.

Referring to FIG. 4, each element (11, 13, 15, 19 and 23) may be arranged on a substrate 12. The substrate 12 may be a p-type epitaxial region.

The photo detector 11 and the storage unit 13 are formed by implanting an n-type dopant in the substrate 12. The storage unit 13 includes an n-type region formed at a lower pan of the boosting gate 15 and a p-type epitaxial region formed at a lower part of the n-type region.

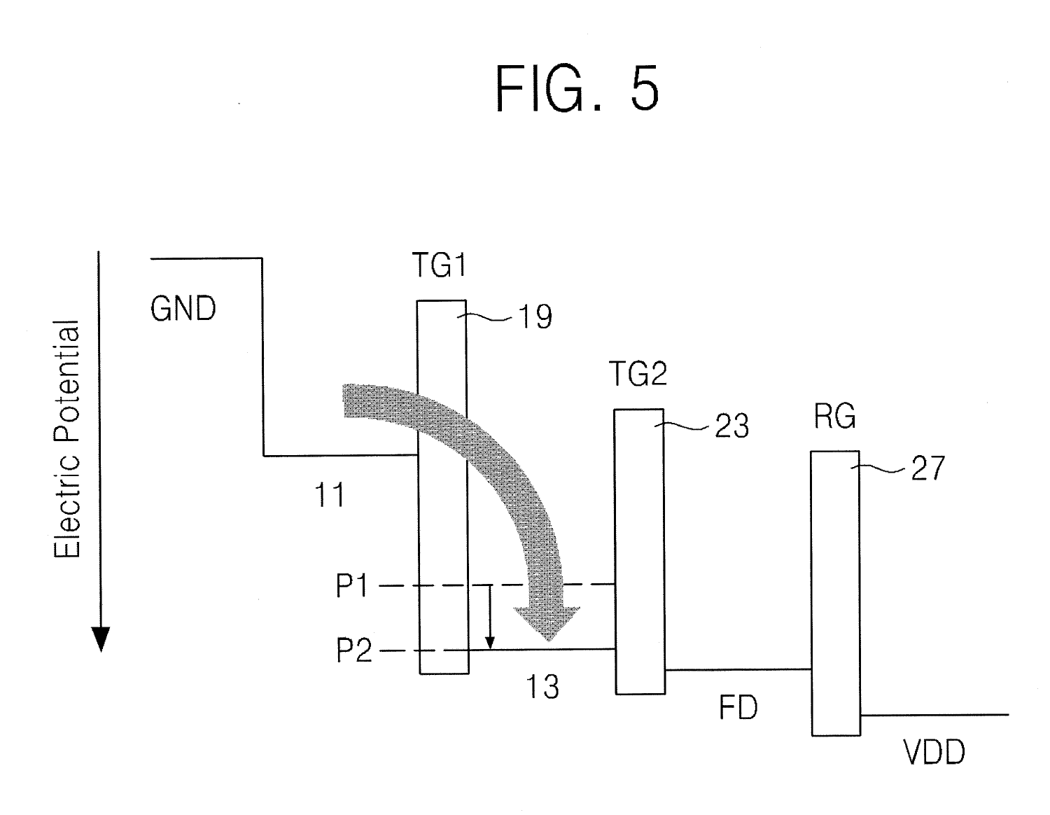

FIG. 5 is an example embodiment of an electric potential diagram of the pixel illustrated in FIG. 2.

Referring to FIGS. 1, 2 and 5, the photo detector 11 has an electric potential P0. When a boosting signal SDG has a first level, e.g., a high level, an electric potential of the storage unit 13 increases from a first electric potential P1 to a second electric potential P2 which is higher than the first electric potential P1.

An electric potential difference exists between the electric potential PO of the photo detector 11 and an electric potential P1 or P2 of the storage unit 13. This electric potential difference causes charges accumulated by the photo detector 11 to be transmitted from the photo detector 11 to the storage unit 13, when a first transmission gate signal TGI having a high level is applied to the first transmission gate 19.

The electric potential difference between the photo detector 11 and the storage unit 13 when an electric potential of the storage unit 13 is the second electric potential P2 is greater than an electric potential difference between the photo detector 11 and the storage unit 13 when an electric potential of the storage unit 13 is the first electric potential PI. Generally, transmission efficiency varies directly with the electric potential difference between a source and a drain. Therefore, charges are transmitted from the photo detector 11 to the storage unit 13 with a higher transmission efficiency when the electric potential difference is PD2 when compared to the lower electric potential difference PD1.

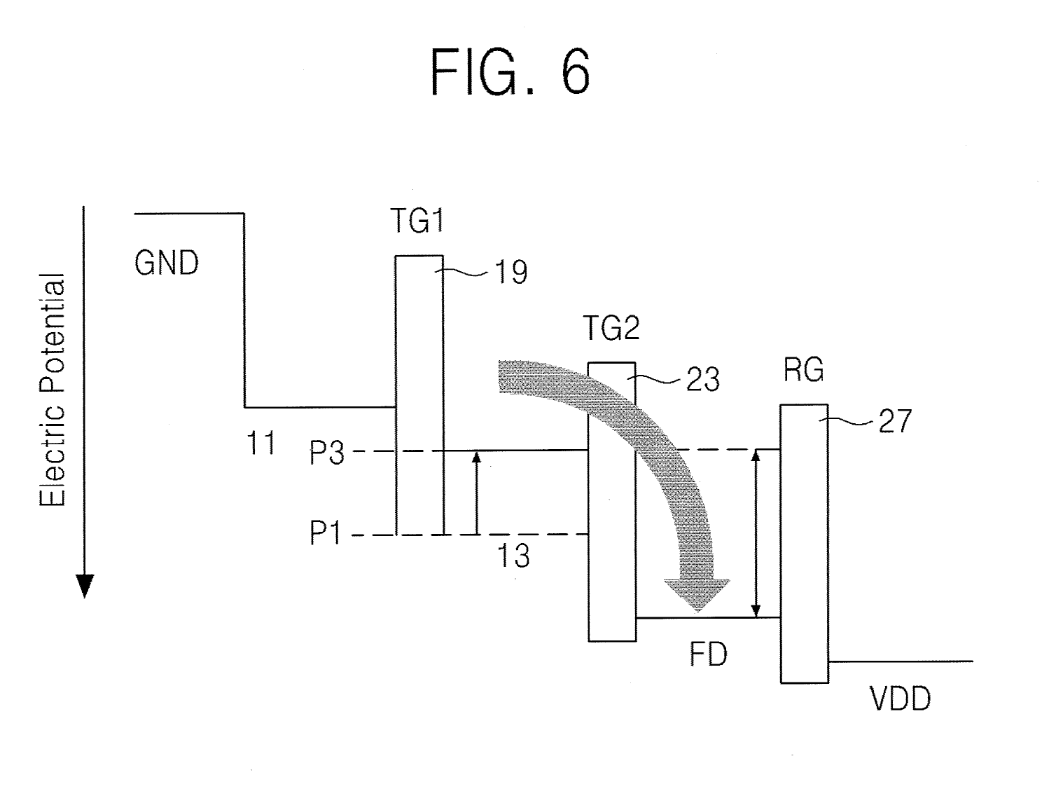

FIG. 6 is another example embodiment of the electric potential diagram of the pixel illustrated in FIG. 2.

Referring to FIGS. 1, 2, 5 and 6, the floating diffusion node FD has an electric potential P4. When the boosting signal SDG has a second level, e.g., a low level, an electric potential of the storage unit 13 decreases from a first electric potential P1 to a third electric potential P3 which is lower than the first electric potential P1.

An electric potential difference exists between the electric potential P4 of the floating diffusion node FD and the electric potential P1 or P3 of the storage unit 13. This electric potential difference causes charges to be transmitted from the storage unit 13 to the floating diffusion node FD, when a second transmission gate signal TG2 having a high level is applied to the second transmission gate 23.

The electric potential difference between the storage unit 13 and the floating diffusion node FD when the electric potential of the storage unit 13 is the third electric potential P3 is greater than an electric potential difference between the storage unit 13 and the floating diffusion node FD when the electric potential of the storage unit 13 is the first electric potential P 1. Therefore, charges are transmitted from the storage unit 13 to the floating diffusion node FD with a higher transmission efficiency when the electric potential of the storage unit 13 is the third electric potential P3 when compared to the first electric potential P1. In addition, more charges may be transmitted to the floating diffusion node FD when an electric potential of the storage unit 13 is the third electric potential P3 than when an electric potential of the storage unit 13 is the first electric potential P1. That is, a capacity of the photo detector 11 may be increased.

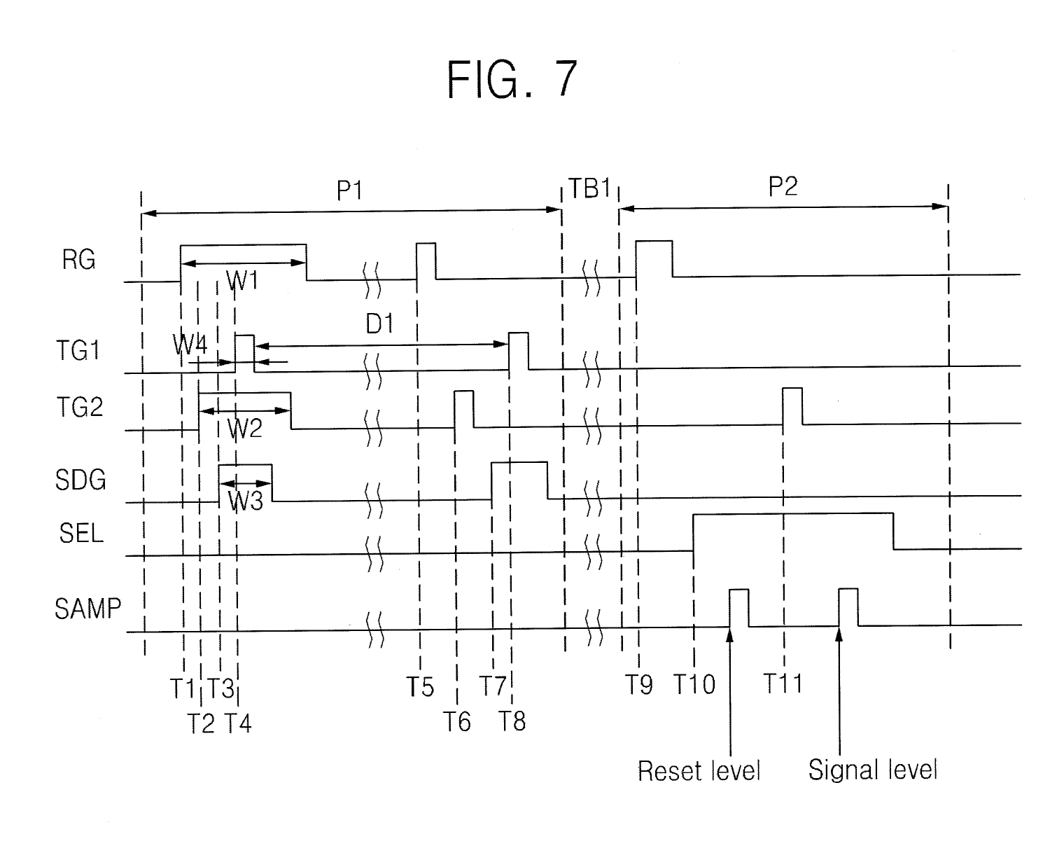

FIG. 7 is a timing diagram of control signals (RG, TG1, TG2, SDG and SEL) for explaining an example embodiment of an operating method of the pixel illustrated in FIG. 2.

Referring to FIGS. 1, 2 and 7, when a reset gate signal RG having a first activation window WI is applied to the reset gate 27 at a first time point TI, the floating diffusion node FD is reset to a supply voltage VDD.

When a second transmission gate signal TG2 having a second activation window W2 is applied to the second transmission gate 23 at a second time point T2, the storage unit 13 is reset to a supply voltage VDD.

When a boosting signal SDG having a third activation window W3 is applied to the boosting gate 15 at a third time point T3 and a first transmission gate signal TG1 having a fourth activation window W4 is applied to the first transmission gate 19 at a fourth time point T4, the photo detector 11 is reset to a supply voltage VDD.

The first activation window W1 includes the second activation window W2 to the fourth activation window W4, the second activation window W2 includes the third activation window W3 and the fourth activation window W4, and the third activation window W3 includes the fourth activation window W4.

According to an example embodiment, a reset gate signal RG having a low level may be applied to the reset gate 27. Here, the reset gate 27, the storage unit 13 or the photo detector 11 are not reset. The photo detector 11 accumulates charges in response to an incident light during a first interval D1.

When a reset gate signal RG having a high level is applied to the reset gate 27 at a fifth time point T5 and a second transmission gate signal TG2 having a high level is applied to the second transmission gate 23 at a sixth time point T6, the storage unit 13 is reset. When a boosting gate signal SDG having a high level is applied to the boosting gate 15 at a seventh time point T7 and a first transmission gate signal TG1 having a high level is applied at an eighth time point T8, accumulated charges are transmitted from the photo detector 11 to the storage unit 13.

When a reset gate signal RG having a high level is applied to the reset gate 27 at a ninth time point T9 and a selection signal SEL is applied to the selection gate 35 at a tenth time point T10, a pixel signal SAMP having a reset level is output to the column line 37. When the second transmission gate signal TG2 having a high level is applied to the second transmission gate 23 at an eleventh time point T11, charges are transmitted from the storage unit 13 to the floating diffusion node FD. The source follower output transistor 29 converts charges stored in the floating diffusion node FD into an output voltage Vout.

When a selection signal SEL is applied to the selection gate 35, a pixel signal SAMP having a signal level, e.g., an output voltage Vout, is output to the column line 37. When the pixel signal SAMP is output this is called a global shutter mode, in which the entire frame is exposed in the same period. As shown in FIG. 7, there exists is a break time TB1 between a first period P1 and a second period P2 when using a global shutter mode.

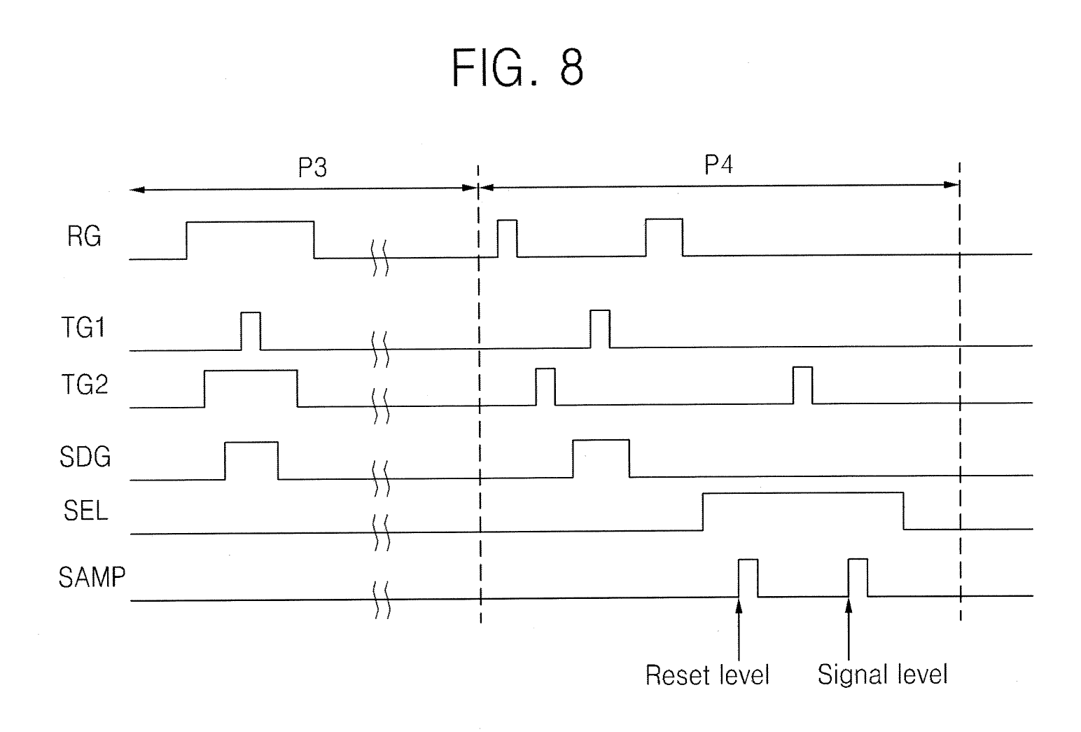

FIG. 8 is a timing diagram of control signals (RG, TG1, TG2, SDG and SEL) for explaining another example embodiment of the operating method of the pixel illustrated in FIG. 2. A level of each signal (RG, TG1, TG2, SDG and SEL) of FIG. 8 is similar to a level of each signal of FIG. 7, so that explanation for each signal is omitted. There is a break time TB1 between a first period P1 and a second period P2 in FIG. 7 and there is no break time between a third period P3 and a fourth period P4 in FIG. 8. When a sampling signal SAMP is output as shown in FIG. 8 this is called a rolling shutter mode, in which each frame period P3 and P4 is recorded not from a snapshot of a single point in time, but rather by scanning across the frame either vertically or horizontally.

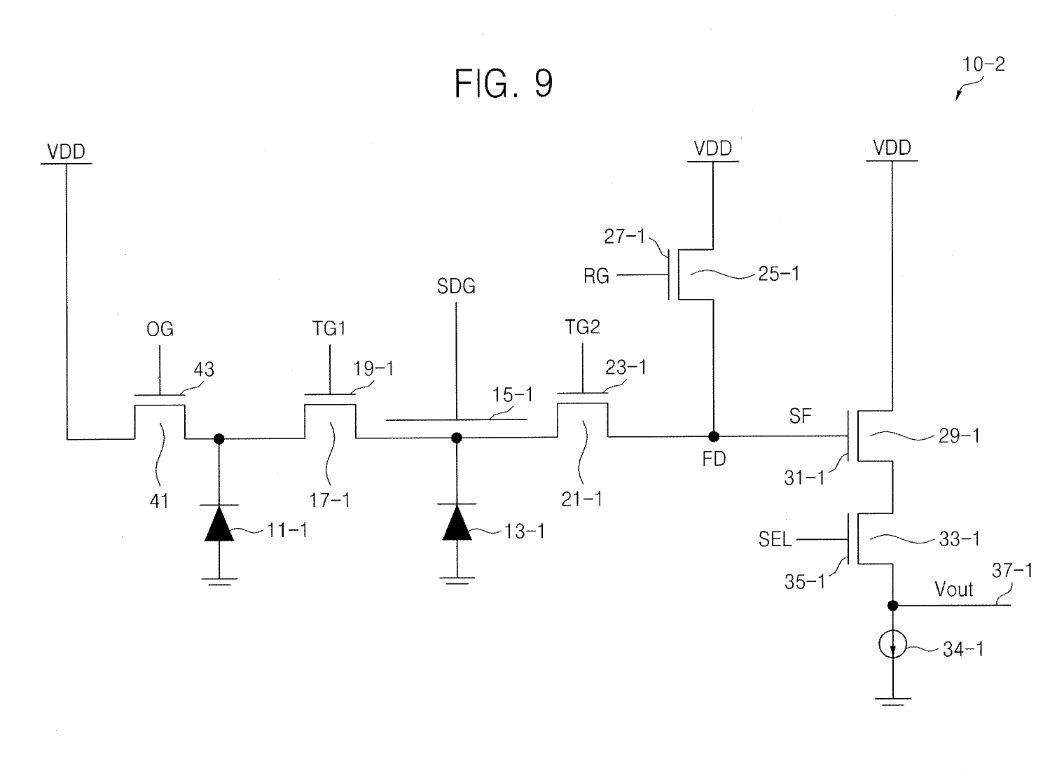

FIG. 9 is a circuit diagram depicting another example embodiment of the pixel embodied in the pixel array illustrated in FIG. 1. Referring to FIGS. 1 and 9, a pixel 10-2 according to another example embodiment of the pixel 10 includes a photo detector 11-1, a storage unit 13-1, a first transmission transistor 17-1, a second transmission transistor 21-1, a reset transistor 25-1, a source follower output transistor 29-1, a selection transistor 33-1, an overflow transistor 41 and a current source 34-1.

Each element of the pixel 10-2 except for the overflow transistor 41 has a structure and a function similar to an element of the pixel 10-1 illustrated in FIG. 2, so that explanation for this is omitted. The overflow transistor 41 is connected between a node supplying a supply voltage VDD and the photo detector 11-1. The overflow transistor 41 includes the overflow gate 43. The overflow gate 43 is used to prevent charges from flowing over the photo detector 11-1. The overflow transistor 41 is activated by an overflow gate signal OG.

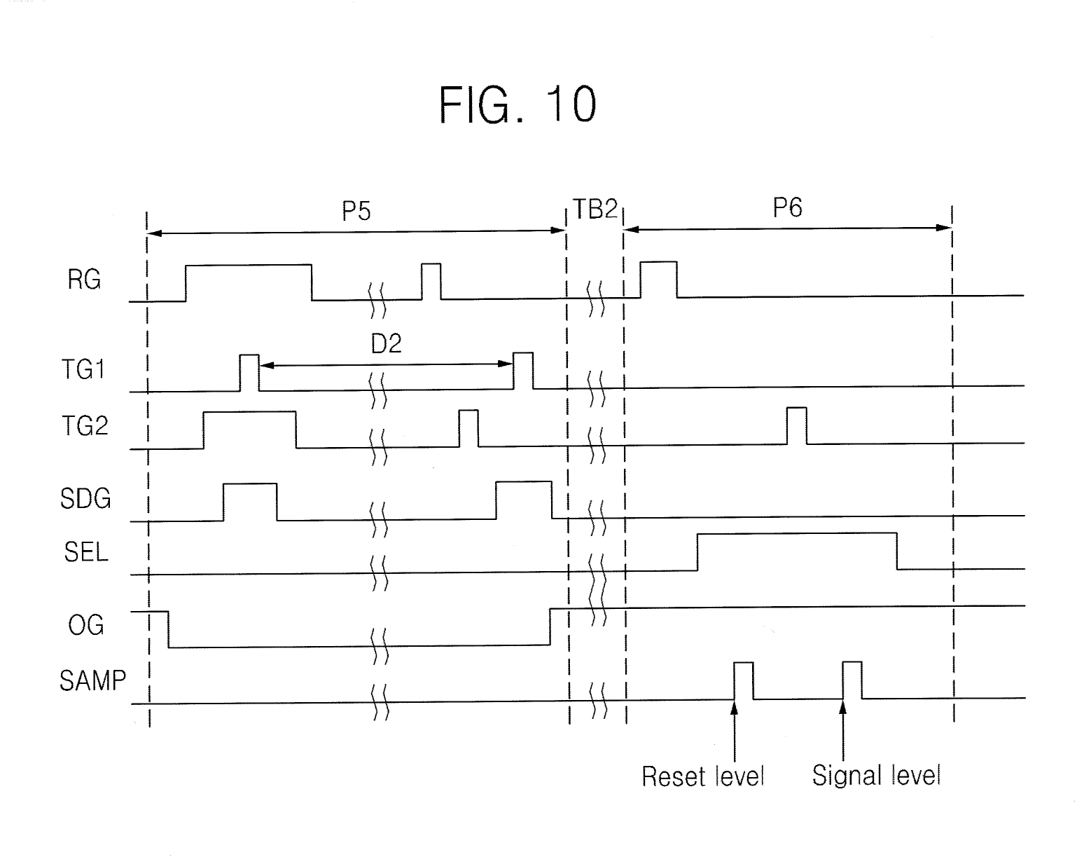

FIG. 10 is a tuning diagram of control signals (RG, TG1, TG2, SDG, SEL and OG) for explaining an example embodiment of an operating method of the pixel illustrated in FIG. 9. Referring to FIGS. 9 and 10, after the photo detector 11-1 accumulates charges in response to an incident light during a second interval D2, an overflow gate signal OG having a high level is applied to the overflow gate 43. Subsequently accumulated charges are prevented from flowing over the photo detector 11-1. A level of each signal (RG, TG I, TG2, SDG and SEL) of FIG. 10 except for an overflow gate signal OG is similar to a level of each signal of FIG. 7. Accordingly, explanation for each signal is omitted.

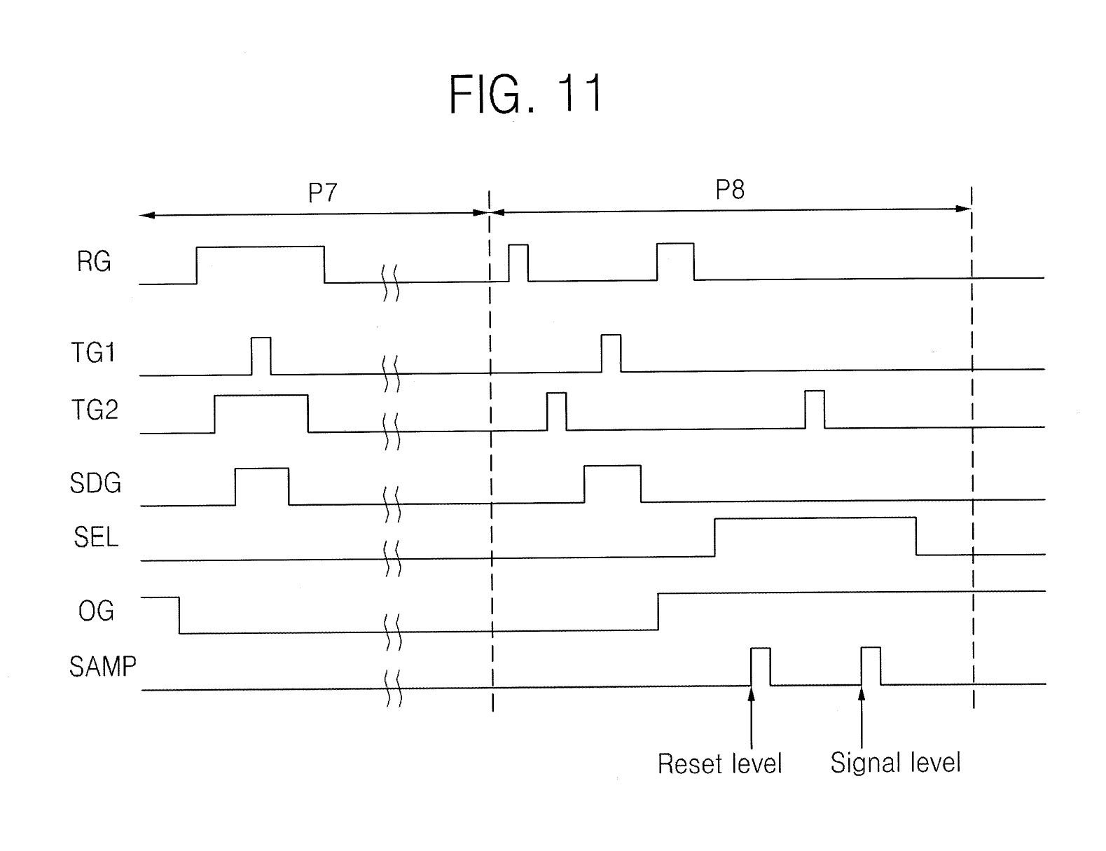

FIG. 11 is a timing diagram of control signals (RG, TG1, TG2, SDG, SEL and OG) for explaining another example embodiment of the operating method of the pixel illustrated in FIG. 9. Referring to FIGS. 9 and 11, a level of each signal (RG, TG1, TG2 SDG, SEL and OG) of FIG. 11 is similar to a level of each signal of FIG. 10. Accordingly, explanation for each signal is omitted. However, there is a break time TB2 between a first period P5 and a second period P6 illustrated in FIG. 10 and there is no break time between a third period P7 and a fourth period P8 illustrated in FIG. 11.

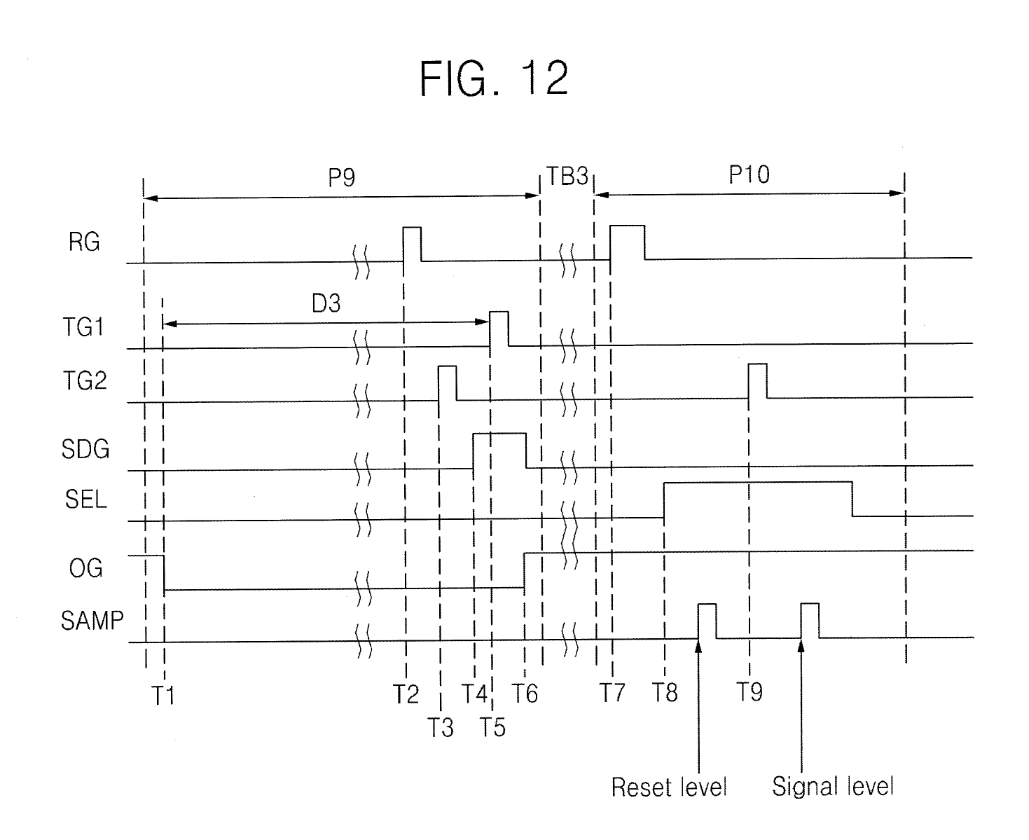

FIG. 12 is a timing diagram of control signals (RG, TG1, TG2, SDG, SEL and OG) for explaining still another example embodiment of the operating method of the pixel illustrated in FIG. 9. Referring to FIGS. 9 and 12, the photo detector 11-1 may be reset to a supply voltage VDD by applying an overflow gate signal OG having a high level to the overflow gate 43 at a first time point T1.

The photo detector 11-1 accumulates charges in response to an incident light during a first interval D3.

When a reset gate signal RG having a high level is applied to a reset gate 27-1 at a second time point T2 and a second transmission gate signal TG2 having a high level is applied to a second transmission gate 23 at a third time point T3, a storage unit 13-1 is reset. When a boosting gate signal SDG having a high level is applied to a boosting gate 15-1 at a fourth time point T4 and a first transmission gate signal TG1 having a high level is applied at a fifth time point T5, accumulated charges are transmitted from the photo detector 11-1 to the storage unit 13-1.

An overflow gate signal OG having a high level is applied to the overflow gate 43 at a sixth time point T6. When a reset gate signal RG having a high level is applied to a reset gate 27-1 at a seventh time point T7 and a selection signal SEL is applied to a selection gate 35-1 at an eighth time point T8, a pixel signal SAMP having a reset level is output to a column line 37-1.

When a second transmission gate signal TG2 having a high level is applied to a second transmission gate 23-1 at a ninth time point T9, charges are transmitted from the storage unit 13-1 to the floating diffusion node FD. A source follower output transistor 29-1 converts charges stored in the floating diffusion node FD into an output voltage Vout.

When a selection signal SEL is applied to a selection signal 35-1, a pixel signal SAMP having a signal level, e.g., an output voltage Vout, is output to the column line 37-1.

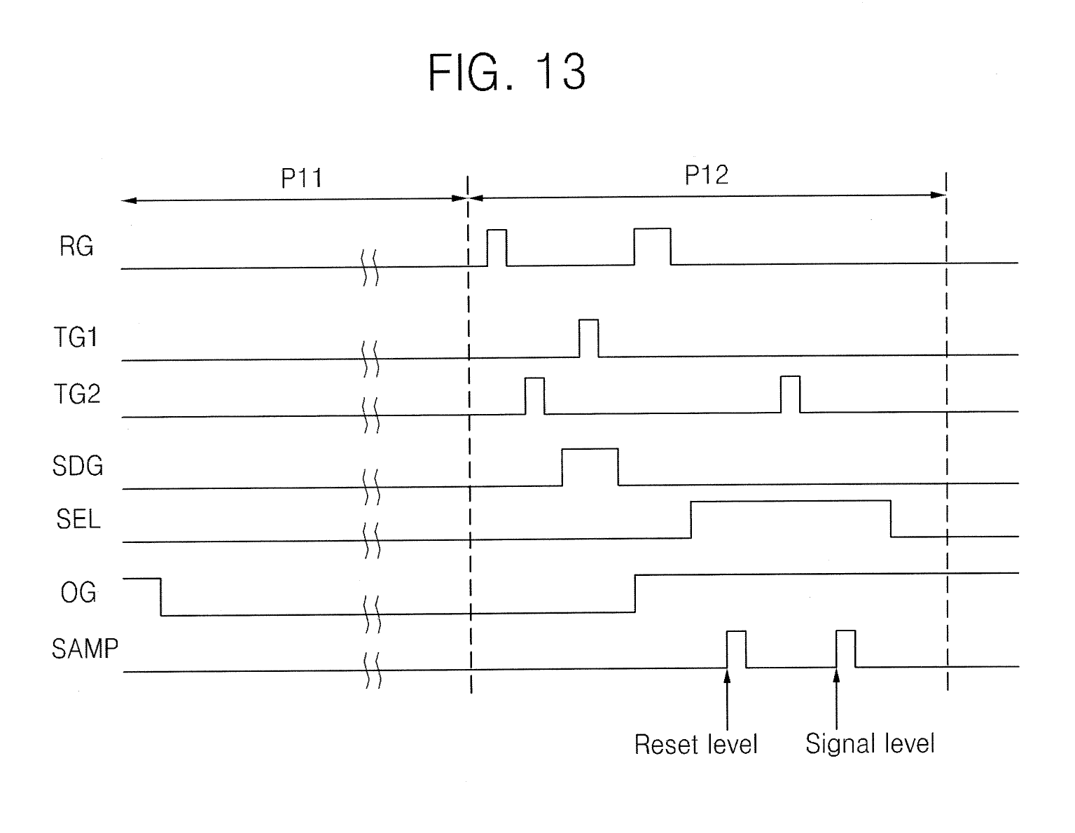

FIG. 13 is a timing diagram of control signals (RG, TG1, TG2, SDG, SEL, and OG) for explaining another example embodiment of the operating method of the pixel illustrated in FIG. 9. Referring to FIGS. 9 and 13, a level of each signal (RG, TG1, TG2, SDG, SEL and OG) of FIG. 13 is similar to a level of each signal of FIG. 12. Accordingly, explanation for each signal is omitted. However, there is a break time TB3 between a first period P9 and a second period P10 illustrated in FIG. 12, and there is no break time between a third period P11 and a fourth period P12 illustrated in FIG. 13.

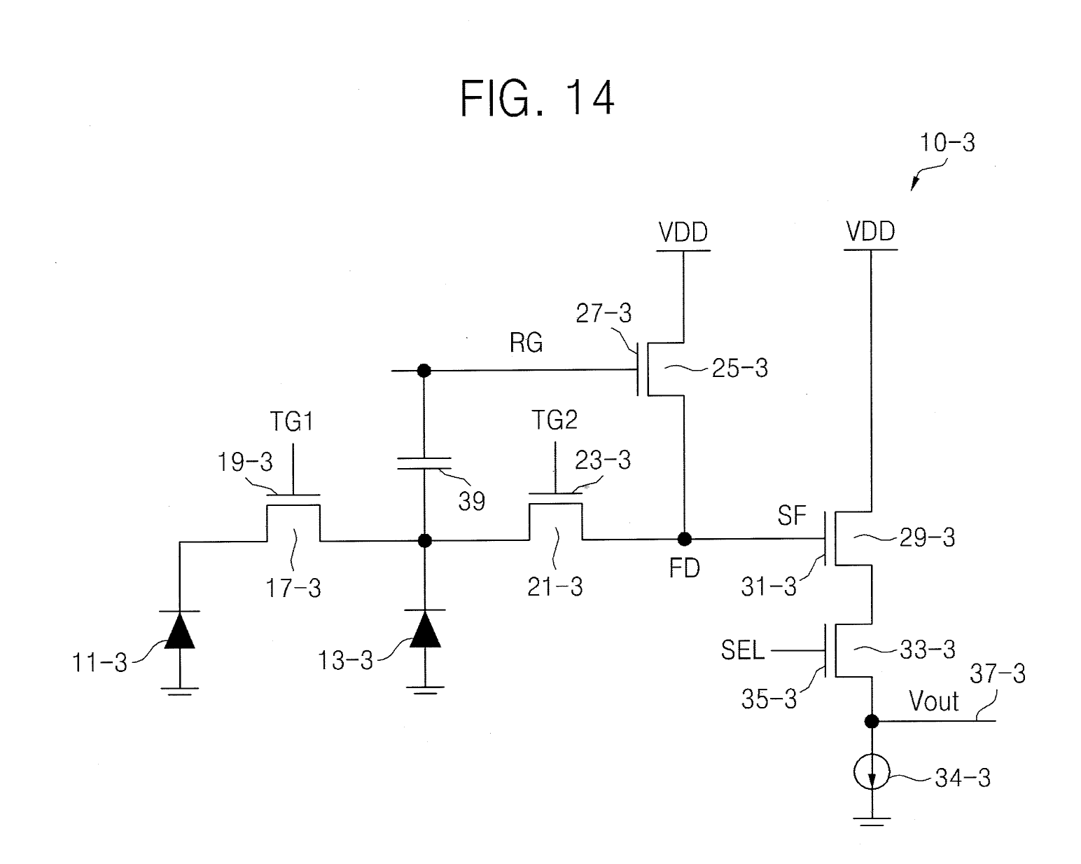

FIG. 14 is a circuit diagram depicting still another example embodiment of the pixel embodied in the pixel array illustrated in FIG. 1. Referring to FIGS. 1 and 14, a pixel 10-3 according to still another example embodiment of the pixel 10 includes a photo detector 11-3, a storage unit 13-3, a first transmission transistor 17-3, a second transmission transistor 21-3, a reset transistor 25-3, a source follower output transistor 29-3, a selection transistor 33-3, a current source 34-3 and a coupling circuit 39.

The photo detector 11-3 accumulates charges in response to an incident light. The photo detector 11-3 may be a photo diode, a photo transistor or a pinned photodiode. The storage unit 13-3 stores the charges. The storage unit 13-3 may be embodied in a storage diode.

The first transmission transistor 17-3 is connected between the photo detector 11-3 and the storage unit 13-3. The first transmission transistor 17-3 includes a first transmission gate 19-3. The first transmission gate 17-3 is used to transmit the charges from the photo detector 11-3 to the storage unit 13-3. The first transmission transistor 17-3 is activated by a first transmission gate signal TG1. For example, when the first transmission gate signal TG1 is a high level, the first transmission transistor 17-3 may be activated.

The second transmission transistor 21-3 is connected between the floating diffusion node FD and the storage unit 13-3. The second transmission transistor 21-3 includes a second transmission gate 23-3. The second transmission gate 23-3 is used to transmit the charges from the storage unit 13-3 to the floating diffusion node FD. The second transmission transistor 21-3 is activated by a second transmission gate signal TG2. For example, when the second transmission gate signal TG2 is at a high level, the second transmission transistor 21-3 may be activated.

The reset transistor 25-3 is connected between a node supplying a supply voltage VDD and the floating diffusion node FD. The reset transistor 25-3 includes the reset gate 27-3. The reset gate 27-3 is used to reset the photo detector 11-3, the storage unit 13-3 or the floating diffusion node FD. The reset transistor 25-3 is activated by a reset gate signal RG. For example, when a reset gate signal RG is at a high level, the reset transistor 25-3 may be activated. In addition, the reset gate 27-3 along with the coupling circuit 39 is used to transmit charges from the photo detector 11-3 to the storage unit 13-3 or to transmit the charges from the storage unit 13-3 to the floating diffusion node FD. The coupling circuit 39 is connected between the reset gate 27-3 and the storage unit 13-3. For example, the coupling circuit may be a capacitor.

The source follower output transistor 29-3 includes the source follower gate 31-3. The source follower gate 31-3 is connected to the floating diffusion node FD. The source follower output transistor 29-3 converts charges stored in the floating diffusion node FD into an output voltage Vout.

The selection transistor 33-3 is connected between a source of the source follower output transistor 29-3 and a ground. The selection transistor 33-3 includes a selection gate 35-3. The selection gate 35-3 is used to output an output voltage Vout to the column line 37-3 selectively in response to a selection signal SEL. For example, when the selection signal SEL is at a high level, the selection gate 35-3 outputs an output voltage Vout to the column line 37-3 as a pixel signal. The current source 34-3 operates as an active load.

A plurality of control signals (TG1, TG2, RG and SEL) are output from the row driver 130.

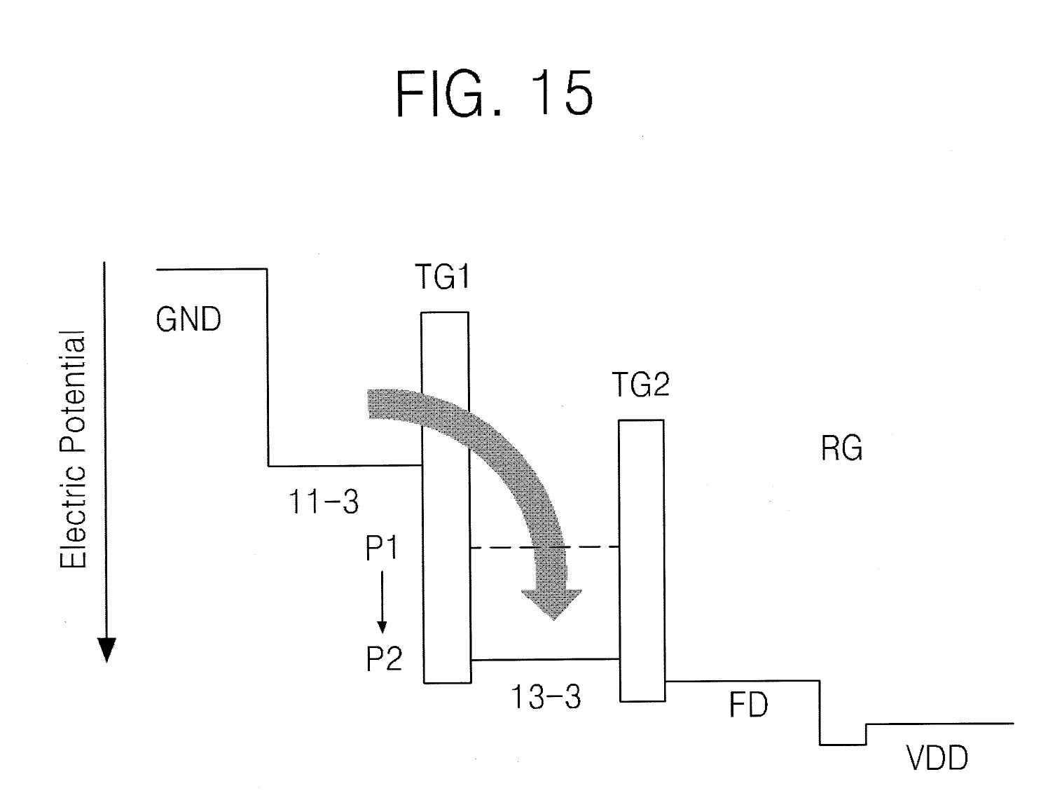

FIG. 15 is an example embodiment of an electric potential diagram of the pixel illustrated in FIG. 14.

Referring to FIGS. 1, 14 and 15, when a reset gate signal RG has a first level, e.g., a high level, an electric potential of the storage unit 13-3 increases from a first electric potential P1 to a second electric potential P2 which is higher than the first electric potential P1.

An electric potential difference exists between the electric potential PO of the photo detector 11-3 and an electric potential P1 or P2 of the storage unit 13. This electric potential difference causes charges accumulated by the photo detector to be transmitted from the photo detector 11-3 to the storage unit 13-3, when a first transmission gate signal TG1 having a high level is applied to the first transmission gate 19-3.

The electric potential difference between the photo detector 11-3 and the storage unit 13-3 when the electric potential of the storage unit 13-3 is the second electric potential P2 is greater than the electric potential difference between the photo detector 11-3 and the storage unit 13-3 when the electric potential of the storage unit 13-3 is the first electric potential P1. Therefore, charges are transmitted from the photo detector 11-3 to the storage unit 13-3 with a higher transmission efficiency when the electric potential of the storage unit 13-3 is the second electric potential P2 when compared to the first electric potential P1.

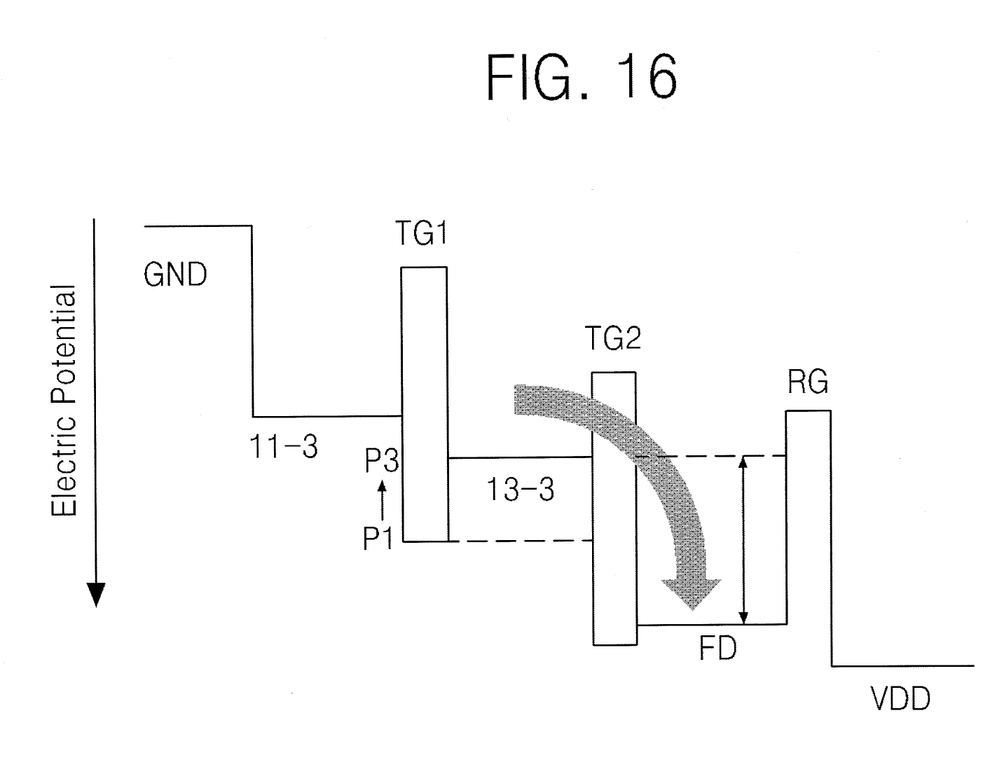

FIG. 16 is another example embodiment of the electric potential diagram of the pixel illustrated in FIG. 14.

Referring to FIGS. 1, 14 and 16, the floating diffusion node PF has an electric potential P4. When a reset gate signal RG has a second level, e.g., a low level, an electric potential of the storage unit 13-3 decreases from the first electric potential P1 to a third electric potential P3 which is lower than the first electric potential P1.

An electric potential difference exists between the electric potential P4 of the floating diffusion node FD and the electric potential P1 or P3 of the storage unit 13-3. This electric potential difference causes charges to be transmitted from the storage unit 13-3 to the floating diffusion node FD, when a second transmission gate signal TG2 having a high level is applied to the second transmission gate 23-3.

The electric potential difference between the storage unit 13-3 and the floating diffusion node FD when the electric potential of the storage unit 13-3 is the third electric potential P3 is greater than an electric potential difference between the storage unit 13-3 and the floating diffusion node FD when the electric potential of the storage unit 13-3 is the first electric potential P1. Therefore, charges are transmitted from the storage unit 13-3 to the floating diffusion node FD with a higher transmission efficiency when the electric potential of the storage unit 13-3 is the third electric potential P3 as compared to the first electric potential P1. Additionally, more charges may be transmitted to the floating diffusion node FD when an electric potential of the storage unit 133 is the third electric potential P3 than when an electric potential of the storage unit 13 is the first electric potential P1. That is, a capacity of the photo detector 11-3 may be increased.

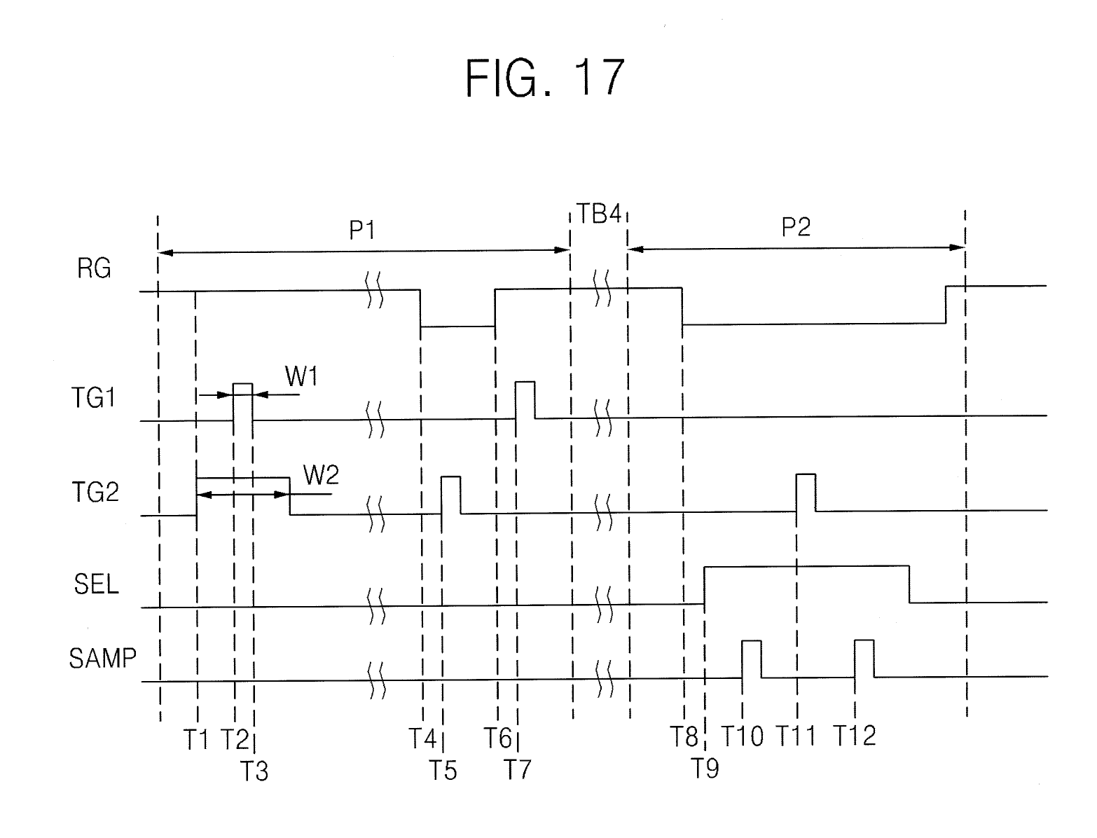

FIG. 17 is a timing diagram of control signals (RG, TG1, TG2 and SEL) for explaining another example embodiment of the operating method of the pixel illustrated in FIG. 14.

Referring to FIGS. 14 and 17, when a reset gate signal RG having a high level is applied to the reset gate 27-3 at a first time point T1 and a second transmission gate signal TG2 having a high level is applied to the second transmission gate 23-3, the floating diffusion node FD and the storage unit 13-3 are reset to a supply voltage VDD.

When a first transmission gate signal TG1 having a high level is applied to the first transmission gate 19-3 at a second time point T2, the photo detector 11-3 is reset to a supply voltage VDD.

A window W2 of a second transmission gate signal TG2 includes a window W1 of a first transmission gate signal TG1.

The photo detector 11-3 accumulates charges in response to an incident light from a third time point T3 to a seventh time point T7. When a reset gate signal RG having a low level is applied to the reset gate 27-3 at a fourth time point T4 and a second transmission gate signal TG2 having a high level is applied to the second transmission gate 23-3 at a fifth time point T5, charges stored in the storage unit 13-3 are transmitted to the floating diffusion node FD.

When a reset gate signal RG having a high level is applied to the reset gate 27-3 at a sixth time point T6 and a first transmission gate signal TG1 having a high level is applied to the first transmission gate 19-3 at a seventh time point T7, charges accumulated in the photo detector 11-3 are transmitted to the storage unit 13-3. In this instance, at the seventh time point T7, the reset gate signal RG is at a high level when the first transmission gate signal TG1 having a high level is applied to the first transmission gate 19-3. Therefore, the charges may be transmitted from the photo detector 11-3 to the storage unit 13-3 efficiently by the coupling circuit 39. This differs from FIG. 7 where at the eighth time point T8, the reset gate signal RG is at a low level when the first transmission gate signal TG1 having a high level is applied to the first transmission gate 19.

When a reset gate signal RG having a high level is applied to the reset gate 27-3 at an eighth time point T8 and a selection signal SEL is applied to the selection gate 35-3 at a ninth time point T9, a pixel signal SAMP having a reset level is output to the column line 37-3 at a tenth time point T10.

When a second transmission gate signal TG2 having a high level is applied to the second transmission gate 23-3 at an eleventh time point T11, charges are transmitted from the storage unit 13-3 to the floating diffusion node FD. The source follower output transistor 29-3 converts charges stored in the floating diffusion node FD into an output voltage Vout.

When a selection signal SEL is applied to the selection gate 35-3, a pixel signal SAMP having a signal level, e.g., an output voltage Vout, is output to the column line 37-3 at a twelfth time point T 12.

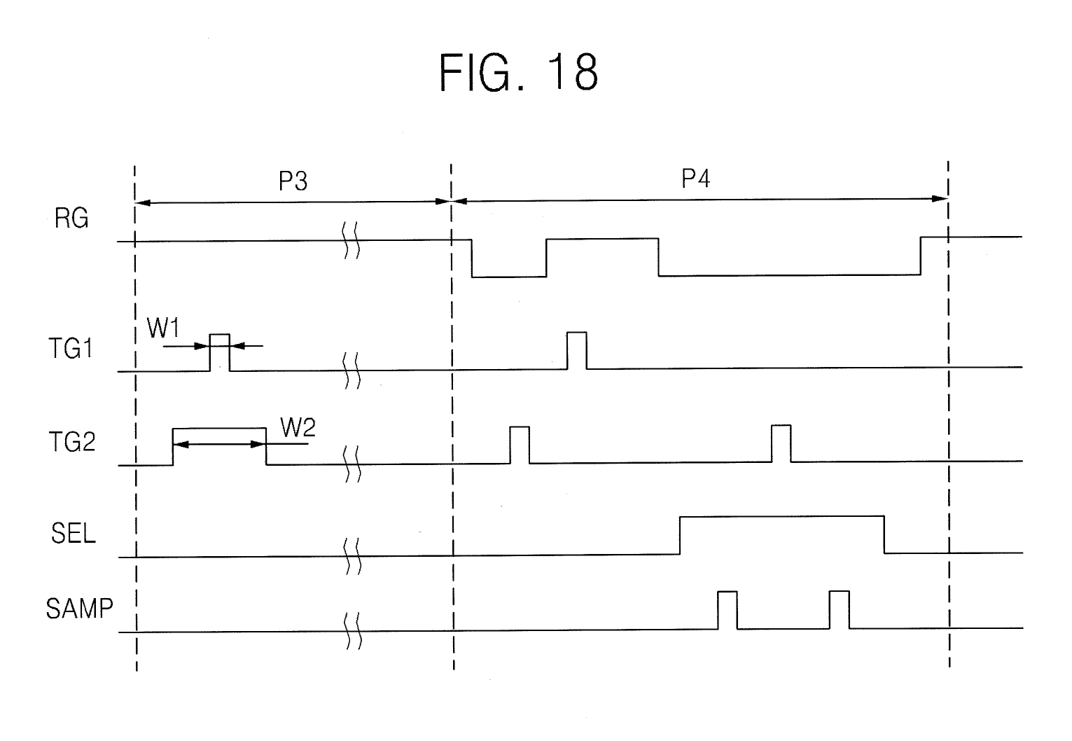

FIG. 18 is a timing diagram of control signals (RG, TG1, TG2 and SEL) for explaining another example embodiment of the operating method of the pixel illustrated in FIG. 14. A level of each signal of FIG. 18 is similar to a level of each signal (RG, TG1, TG2 and SEL) of FIG. 17. Accordingly, explanation for each signal is omitted.

However, there is a break time TB4 between a first period P1 and a second period P2, and there is no break time between a third period P3 and a fourth period P4.

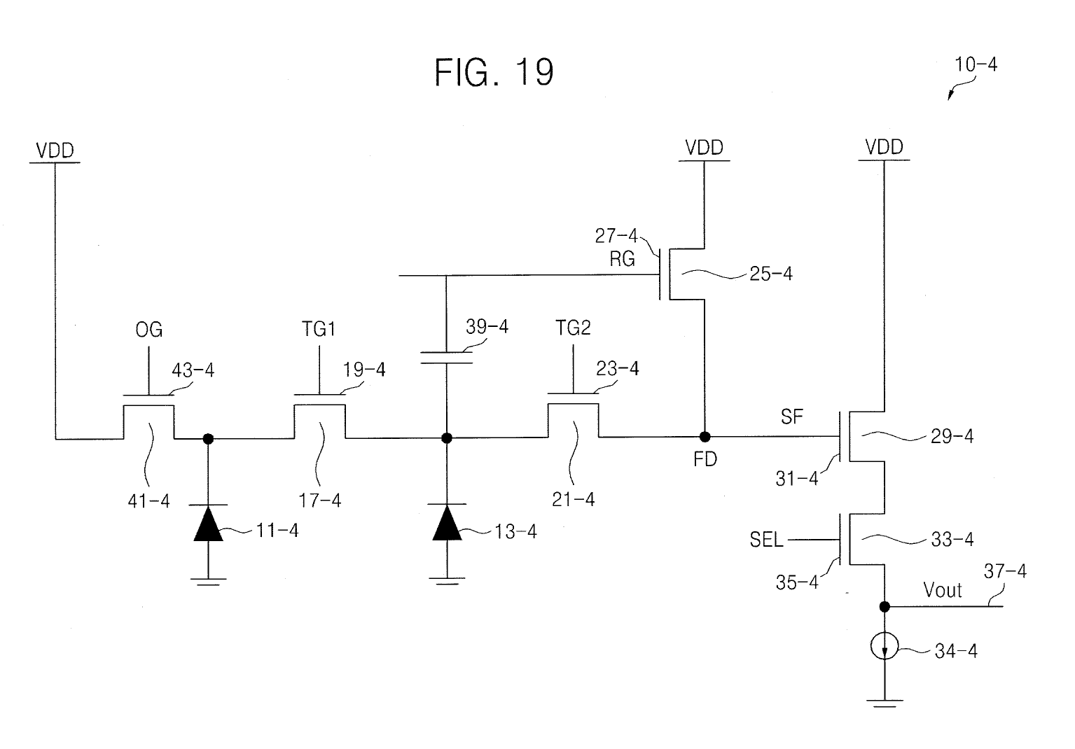

FIG. 19 is a circuit diagram depicting another example embodiment of the pixel embodied in the pixel array illustrated in FIG. 1.

Referring to FIGS. 1 and 19, a pixel 10-4 includes a photo detector 11-4, a storage unit 13-4, a first transmission transistor 17-4, a second transmission transistor 21-4, a reset transistor 25-4, a source follower output transistor 29-4, a selection transistor 33-4, a current source 34-4, a coupling circuit 39-4 and an overflow transistor 41-4.

Each element of the pixel 10-4 except for the overflow transistor 41-4 has an operation and a function similar to an element of the pixel 10-3 illustrated in FIG. 14. The overflow transistor 41-4 is connected between a node supplying a supply voltage VDD and the photo detector 11-4. The overflow transistor 41 includes an overflow gate 43-4. The overflow gate 43-4 is used to prevent charges from flowing over the photo detector 11-1. The overflow transistor 41-4 is activated by an overflow gate signal OG.

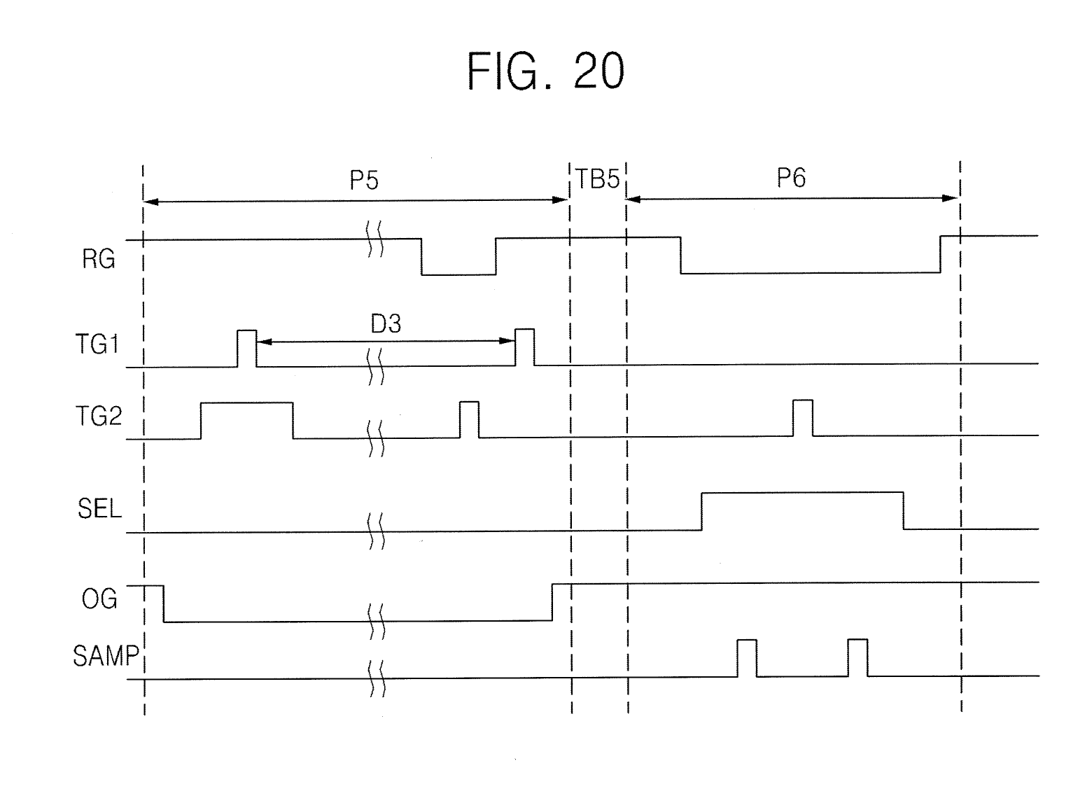

FIG. 20 is a timing diagram of control signals (RG, TG1, TG2, SEL and OG) for explaining another example embodiment of the operating method of the pixel illustrated in FIG. 19. Referring to FIGS. 19 and 20, after the photo detector 11-4 accumulates charges in response to an incident light during a first interval D3, an overflow gate signal OG having a high level is applied to the overflow gate 43-4. Subsequently, accumulated charges may be prevented from flowing over the photo detector 11-4.

A level of each signal (RG, TG1, TG2 and SEL) of FIG. 20 except for an overflow gate signal OG is similar to a level of each signal of FIG. 17. Accordingly, explanation for each signal is omitted.

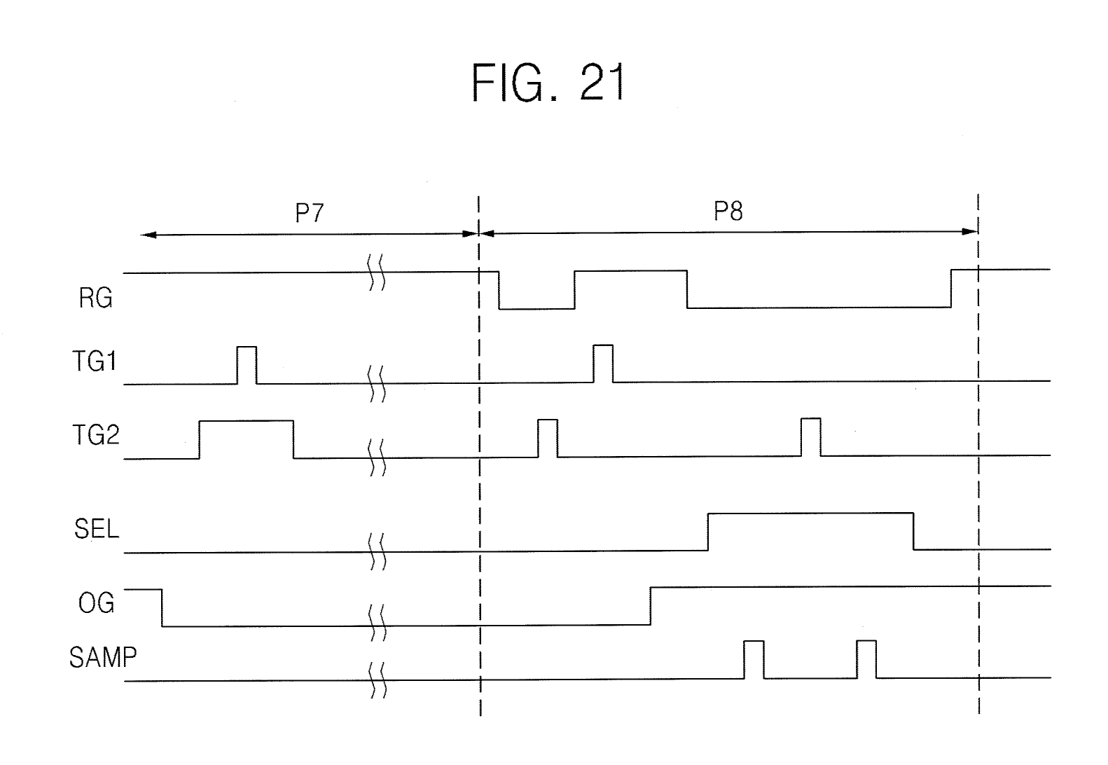

FIG. 21 is a timing diagram of control signals (RG, TG1, TG2, SEL and OG) for explaining another example embodiment of the operating method of the pixel illustrated in FIG. 19. Referring to FIGS. 19 and 21, a level of each signal (RG, TG1, TG2, SEL and OG) of FIG. 21 is similar to a level of each signal of FIG. 20. Accordingly, explanation for each signal is omitted. However, there is a break time TB5 between a first period P5 and a second period P6 illustrated in FIG. 20, and there is no break time between a third period P7 and a fourth period P8 illustrated in FIG. 21.

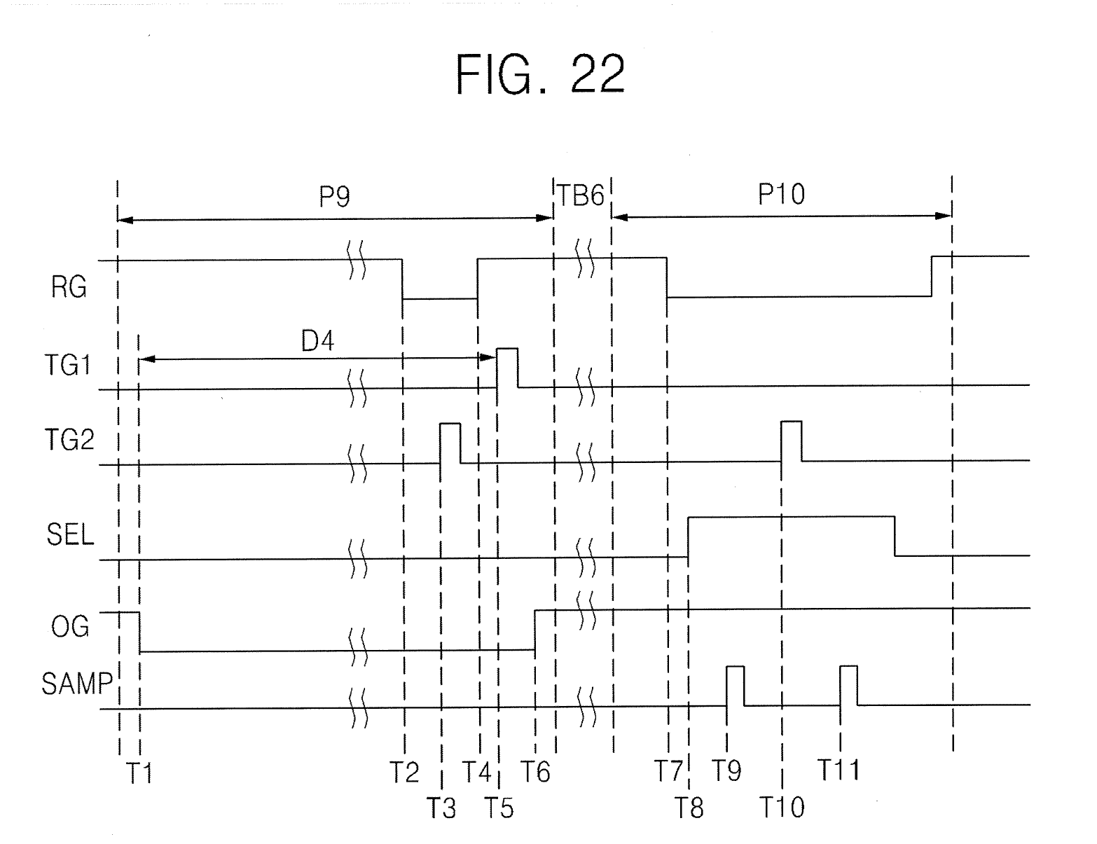

FIG. 22 is a timing diagram of control signals (RG, TG1, TG2, SEL and OG) for explaining still another example embodiment of the operating method of the pixel illustrated in FIG. 19. Referring to FIGS. 19 and 22, the photo detector 11-4 may be reset to a supply voltage VDD by applying an overflow gate signal OG having a high level to the overflow gate 43-4 at a first time point T1.

The photo detector 11-4 accumulates charges in response to an incident light during a first interval D4.

When a reset gate signal RG having a low level is applied to the reset gate 27-4 at a second time point T2 and a second transmission gate signal TG2 having a high level is applied to the second transmission gate 23-4 at a third time point T3, the storage unit 13-4 is reset. When a reset gate signal RG having a high level is applied to the reset gate 27-4 at a fourth time point T4 and a first transmission gate signal TG1 having a high level is applied at a fifth time point T5, accumulated charges are transmitted from the photo detector 11-4 to the storage unit 13-4.

An overflow gate signal OG having a high level is applied to the overflow gate 43-4 at a sixth time point T6. When a reset gate signal RG having a low level is applied to the reset gate 27-4 at a seventh time point T7 and a selection signal SEL is applied to the selection gate 35-4 at an eighth time point T8, a pixel signal SAMP having a reset level is output to the column line 37-4 at a ninth time point T9.

When a reset gate signal RG having a low level is applied to the reset gate 27 at a tenth time point T10 and a second transmission gate signal TG2 having a high level is applied to the second transmission gate 23-4, charges are transmitted from the storage unit 13-4 to the floating diffusion node FD. The source follower output transistor 29-4 converts charges stored in the floating diffusion node FD into an output voltage Vout.

When a selection signal SEL is applied to the selection gate 35-4, a pixel signal SAMP having a signal level, e.g., an output voltage Vout, is output to the column line 37-4 at an eleventh time point T11.

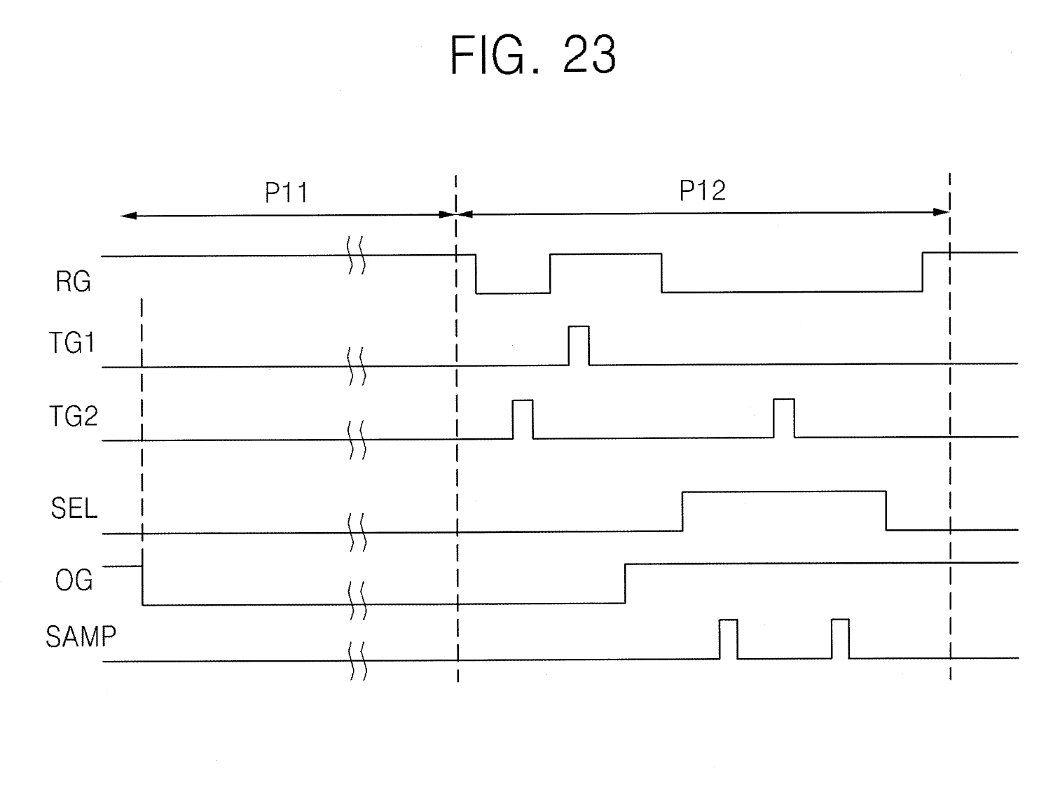

FIG. 23 is a timing diagram of control signals (RG, TG1, TG2, SEL and OG) for explaining still another example embodiment of the operating method of the pixel illustrated in FIG. 19. Referring to FIGS. 19 and 23, a level of each signal (RG, TG1, TG2, SEL and OG) of FIG. 23 is similar to a level of each signal of FIG. 22. Accordingly, explanation for each signal is omitted. However, there is a break time TB6 between a first period P9 and a second period P10 in FIG. 22, and there is no break time between a third period P11 and a fourth period P12 in FIG. 23.

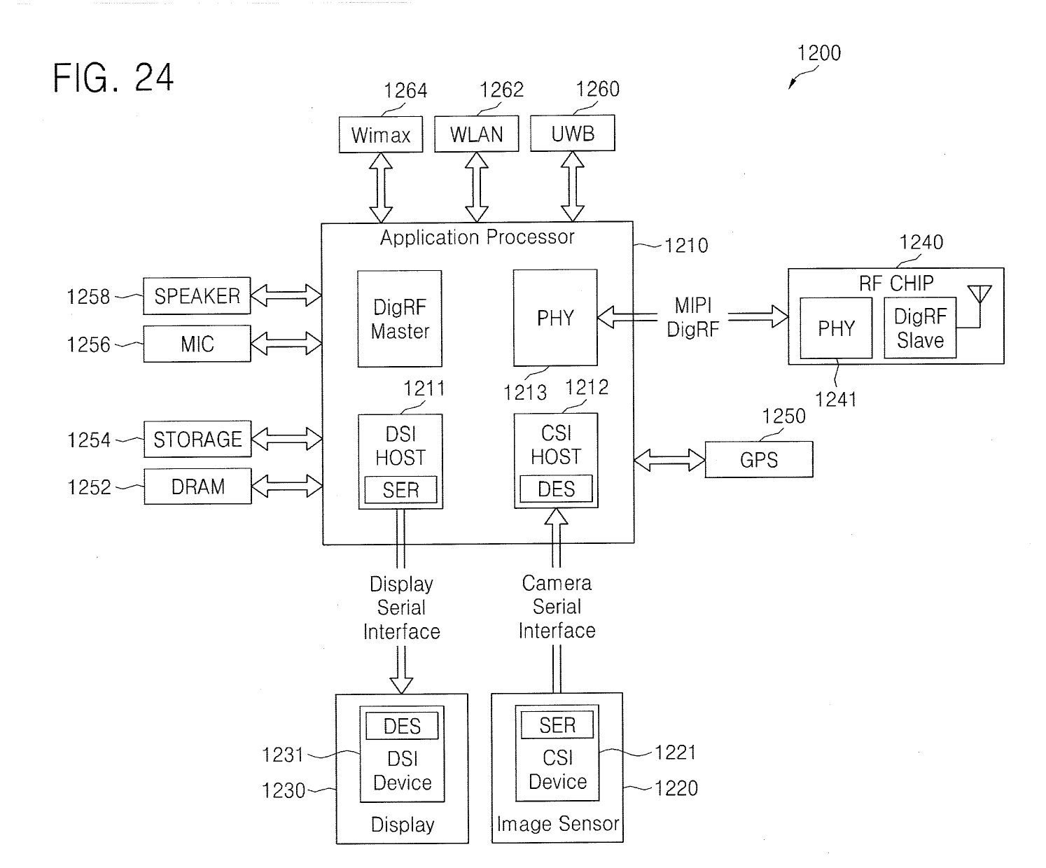

FIG. 24 is a block diagram depicting another example embodiment of the image processing device including the pixel illustrated in FIG. 2, 9, 14 or 19. Referring to FIG. 24, an image processing device 1200 may be embodied in an image processing device which may use or support a mobile industry processor interface (MIPI) ®, e.g., a portable device such as a personal digital assistant (PDA), a portable media player (PMP), a mobile phone, a smart phone or a tablet PC.

The image processing device 1200 includes an application processor 1210, an image sensor 1220 and a display 1230.

A camera serial interface (CSI) host 1212 embodied in the application processor 1210 may perform a serial communication with a CSI device 1221 of the image sensor 1220 through a camera serial interface (CSI). According to an example embodiment, a de-serializer (DES) may be embodied in the CSI host 1212, and a serializer (SER) may be embodied in the CSI device 1221.

The image sensor 1220 may mean an image sensor including the pixel (10-1, 10-2, 10-3 or 10-4) illustrated in FIG. 2, 9, 14 or 19.

A display serial interface (DSI) host 1211 embodied in the application processor 1210 may perform a serial communication with a DSI device 1231 of the display 1230 through a display serial interface. According to an example embodiment, a serializer (SER) may be embodied in the DSI host 1211 and a de-serializer (DES) may be embodied in the DSI device 1231.

The image processing device 1200 may further include a RF chip 1240 which may communicate with the application processor 1210. A PHY 1213 of the image processing device 1200 and a PHY 1241 of the RF chip 1240 may transmit or receive data according to MIPI DigRF. The image processing device 1200 may include a GPS receiver 1250, a memory 1252 like a dynamic random access memory (DRAM), a data storage device 1254 which is embodied in a non-volatile memory like a NAND flash memory, a mike 1256, or a speaker 1258.

Additionally, the image processing device 1200 may communicate with an external device by using at least a communication protocol(or a communication standard), e.g., a ultra-wideband(UWB) 1260, a Wireless LAN(WLAN) 1262, a worldwide interoperability for microwave access(WiMAX) 1264 or a long term evolution(LTETM: not shown).

An image sensor according to an example embodiment of the present inventive concepts, an operating method thereof, and a portable device having the same may increase a transmission efficiency of charges by adjusting an electric potential of a storage unit. In addition, the image sensor, the operating method thereof and the portable device having the same may increase capacity of a photo detector by adjusting an electric potential of a storage unit.

While example embodiments have been particularly shown and described with reference to embodiments thereof, it will be understood by those of ordinary skill in the art that various changes in forms and details may be made therein without departing from the spirit and scope as defined by the following claims.

What is claimed is:

1. An image sensor comprising:
a photo detector configured to accumulate charges in response to an incident light;
a storage unit configured to store the charges;
a first transmission gate configured to transmit the charges from the photo detector to the storage unit;
a second transmission gate configured to transmit the charges from the storage unit to a floating diffusion node;
a reset gate configured to reset the floating diffusion node in response to a reset gate signal; and
a coupling circuit connected between the reset gate and the storage unit.

2. The image sensor of claim 1, wherein the coupling circuit is a capacitor.

3. The image sensor of claim 1, wherein the storage unit is configured to have a first electric potential when the reset gate signal has a high level, and the storage unit is configured to have a second electric potential when the reset gate signal has a low level, the first electric potential being greater than the second electric potential.

4. The image sensor of claim 1, further comprising:
an overflow gate configured to prevent the charges from flowing over the photo detector.

5. The image sensor of claim 1, wherein the photo detector is configured to transmit the charges from the photo detector to the storage unit, if the reset gate signal having the high level is applied to the reset gate.

6. The image sensor of claim 3, wherein the storage unit is configured to transmit the charges from the storage unit to the floating diffusion node, if the reset gate signal having the low level is applied to the reset gate.

7. The image sensor of claim 1, wherein the storage unit is a storage diode.

8. A method for operating an image sensor comprising:
resetting one or more of a photo detector, a storage unit and a floating diffusion node;
accumulating charges in the photo detector; and
applying a reset gate signal having a high level to a reset gate to transmit the charges accumulated by the photo detector from the photo detector to the storage unit.

9. The method of claim 8, wherein the resetting includes:
resetting the floating diffusion node by using the reset gate signal having a high level;
resetting the photo detector by using a first transmission gate signal transmitted during a first activation window; and
resetting the storage unit by using a second transmission gate signal transmitted during a second activation window.

10. The method of claim 9, wherein the second activation window includes the first activation window.

11. The method of claim 9, wherein the resetting includes resetting the photo detector by using an overflow gate signal having a high level.

12. A portable device comprising:
the image sensor of claim 1; and
a display configured to display data processed by the image sensor.

13. The portable device of claim 12, wherein the storage unit is configured to have a first electric potential when the reset gate signal has a high level, and the storage unit is configured to have a second electric potential when the reset gate signal has a low level, the first electric potential being greater than the second electric potential.

14. The portable device of claim 12, further comprising:
an overflow gate configured to prevent the charges from flowing over the photo detector.

15. The portable device of claim 12, wherein the photo detector is configured to transmit the charges to the storage unit, if the reset gate signal having a high level is applied to the reset gate.

16. A pixel array, comprising:
a plurality of pixels, each pixel including,
a photo detector configured to accumulate charges;
a storage unit configured to selectively receive the charges from the photo detector according to a first transmission signal;
a floating diffusion node configured to selectively receive a reset voltage according to a reset signal and selectively receive the charges from the storage unit according to a second transmission signal; and
a coupling circuit configured to increase an electric potential at the storage unit during a period where the storage unit receives the charges from the photo detector.

17. The pixel array of claim 16, further comprising:
an overflow circuit configured to discharge any excess accumulated charges in the photo detector.

18. The pixel array of claim 16, wherein the storage unit is a storage diode and the coupling circuit is a capacitor.

19. An image processing device, comprising:
an image sensor including the pixel array of claim 16; and
a digital signal processor configured to process data received from the image sensor.
